(19) United States
(12) Patent Application Publication
(10) Pub. No.: US 2018/0367857 A1
(43) Pub. Date: Dec. 20, 2018

(54) SYSTEMS AND METHODS FOR RANKING CONTENT SOURCES BASED ON A NUMBER OF MEDIA ASSETS IDENTIFIED TO BE INTERESTING TO A USER

(71) Applicant: Rovi Guides, Inc., San Carlos, CA (US)

(72) Inventor: David Gerald Wittke, Simi Valley, CA (US)

(21) Appl. No.: 15/626,320

(22) Filed: Jun. 19, 2017

(51) Int. Cl. H04N 21/466; H04N 21/25; H04N 21/45; H04N 21/482; H04N 21/442; H04N 21/24

(52) U.S. Cl. CPC H04N 21/4668; H04N 21/251; H04N 21/2407; H04N 21/4826; H04N 21/44204; H04N 21/4532

(57) ABSTRACT

Systems and methods are described for recommending a media asset provider to a user based on an amount of media assets that the user is likely to consume. Characteristics associated with the user may be transmitted to multiple media asset providers. Each media asset provider may determine which media assets match the transmitted characteristics and transmit results back to a device of the user. Based on the received results, an amount of media assets from each media asset provider that the user is likely to consume is determined. Indicators for the media asset providers may be displayed on the device and visually distinguished based on the amount of media assets from each media asset provider that the user is likely to consume.

### BACKGROUND

Given the plethora of media content available to modern consumers, it may be difficult for a user to determine which media content providers to chose for media consumption. For example, in addition to the numerous broadcast content providers (e.g., cable and satellite television services), there is a variety of Internet streaming services with similar, and in some cases overlapping, media content.

Using many conventional systems, a user may have to access each content provider individually to determine which media assets that particular content provider recommends for him or her. This may be a lengthy process for a user, as he or she may have to manually access different content providers individually to get the recommendations. Some conventional systems attempt to solve this problem by retrieving recommendations for a user from multiple content sources and providing the recommendations in a single list. However, these systems do not indicate to a user which of multiple providers the user should access for media consumption.

### SUMMARY

Accordingly, systems and methods are described herein for recommending a media asset provider to a user based on the amount of media assets that the user is likely to enjoy consuming. For example, characteristics associated with the user (e.g., favorite actors, genres, studios, etc.) may be transmitted, from the user's device, to multiple media asset providers. Each media asset provider may compare the transmitted characteristics with metadata of each media asset (e.g., an actor in the media asset) that is available from the media asset provider and transmit the results of the comparison to the device. The results may include whether each transmitted characteristic matches metadata of each media asset available from the media asset provider. Based on the received results, an amount of media assets from each media asset provider that the user is likely to consume is determined. Indicators for the media asset providers may be differentiated based on the amount of media assets from each media asset provider that the user is likely to consume (e.g., the media asset provider with the most media assets that the user is likely to consume is displayed in a larger font).

In some aspects, a media guidance application may recommend a media asset provider of a plurality of media asset providers to a user based on how many media assets available from the media asset provider the user is likely to consume. Specifically, the media guidance application may transmit, to each of a plurality of media asset providers, a plurality of characteristics associated with a user. For example, the media guidance application may retrieve stored user preferences for particular actors, directors, genres, or any other preference associated with media assets as the plurality of characteristics. The stored user preferences may be explicitly set by the user (e.g., in a favorites screen) or may be determined from a viewing history associated with the user. As a specific example, if a user has consumed multiple movies starring Tom Cruise, the media guidance application may determine that Tom Cruise is a favorite actor of the user. Upon determining the plurality of characteristics, the media guidance application may determine which media asset providers to transmit the plurality of characteristics to. In some embodiments, the media guidance application may customize the transmission based on characteristics that each media asset provider supports, as discussed further below.

The media guidance application may receive a data set from each media asset provider with data describing how or to what degree each media asset available from each media asset provider matches the set of characteristics that was transmitted. Specifically, the media guidance application may receive, from each media asset provider of the plurality of media asset providers, media asset preference data, where the media asset preference data includes, for each media asset available from each respective media asset provider, an indication of whether each of the plurality of characteristics matches metadata associated with each respective media asset. For example, the media guidance application may receive a true/false indication of whether a favorite genre of the user (e.g., action) matches the genre of a movie (e.g., Edge of Tomorrow) available from a particular media asset provider. As another example, the user may have five favorite actors, four of whom appear in a particular movie. In this situation, the media asset preference data, in addition to storing an indication of a match (e.g., a Boolean value that is set to “true”) for the “actor” characteristic, may also store the number four indicating that more than one match was found. The media guidance application may utilize this information to assign a higher probability that the user will consume the media asset.

The media guidance application may extract, from the media asset preference data for each media asset, a plurality of indications, where each indication of the plurality of indications indicates whether a characteristic of the plurality of characteristics matches metadata associated with a corresponding media asset. For example, the media guidance application may extract a value (e.g., a Boolean) for whether a particular characteristic (e.g., genre) matches the metadata of a media asset from the media asset preference data. As another example, the media guidance application may process the media asset preference data to group indications that refer to the same media asset. The media guidance application may also standardize the indications from different media asset providers during extraction from the media asset preference data. For example, if one media asset provider transmits binary indications about whether a match was determined and another media asset provider transmits indications on a scale of 1-10, the media guidance application may convert the indications to a common format in order to more easily assign probabilities to each media asset that the user will consume each media asset.

The media guidance application may determine, based on a respective plurality of indications for each media asset, an amount of characteristics that match metadata associated with the corresponding media asset. For example, the media guidance application may determine whether a characteristic matches based on the received media asset preference data. In some embodiments, a particular characteristic (e.g., actor) may be associated with a Boolean value, set to either true or false, for a particular media asset from a particular media asset provider. The media guidance application may determine a match between the characteristic and the metadata based on the true or false value without further processing. In some embodiments, a particular characteristic may be associated with a numeric value. The media guidance application may utilize a rule set to determine whether a match between the characteristic and the metadata was determined based on the numeric value. As a specific example, if the media guidance application extracts a value of “0.5” (e.g., indicating a 50% match between a given characteristic and metadata of a media asset), then the media guidance application may determine whether a 50% match should be considered a match based on a rule set. In other words, the media guidance application may determine whether the value is above or below a threshold to be considered a binary match (e.g., above 70% is a match, but below is not a match). The media guidance application may sum the number of matches between the plurality of characteristics and metadata of a given media asset to calculate the amount of characteristics that matched. In some embodiments, the media guidance application may determine whether multiple values for a given characteristic match and factor this into calculation of the amount, as discussed further below. For example, if two of the user's favorite actors are in a media asset, then the media guidance application may determine two separate matches when calculating the amount.

The media guidance application may determine, for each media asset based on the amount of characteristics that match the metadata, a probability that the user will consume each respective media asset. As an example, the media guidance application may determine that the percentage of characteristics that match out of the total number of the plurality of characteristics is the probability. In this example, if 5 out of 10 characteristics match for a media asset, the media guidance application may assign 50% as the probability for the media asset. As another example, the media guidance application may weigh certain factors higher or lower (e.g., based on user preferences). In this example, if a user has a strong preference for his or her favorite actors being in media assets, but less of a preference for the genre, the media guidance application may assign a media asset matching only the actor characteristic a higher probability than another media asset matching only the genre characteristic.

The media guidance application may use the calculated probabilities that the user will consume each media asset from a particular media asset provider to calculate an overall score for the media asset provider. Specifically, the media guidance application may calculate, based on a plurality of probabilities associated with each respective media asset provider of the plurality of media asset providers, a score for each media asset provider of the plurality of media asset providers. For example, the media guidance application may sum the probability for every media asset from a particular media asset provider to calculate the score for the media asset provider. In some embodiments, the media guidance application may normalize the scores based on the total number of media assets available from each media asset provider.

The media guidance application may generate for display indicators (e.g., graphics) for each media asset provider formatted based on the calculated scores. Specifically, the media guidance application may generate for display a first indicator for a first media asset provider of the plurality of media asset providers and a second indicator for a second media asset provider of the plurality of media asset providers, wherein the first indicator is visually distinguished from the second indicator based on a first score calculated for the first media asset provider and a second score calculated for the second media asset provider. For example, the media guidance application may receive a user input from the user to generate a display with indicators of media asset providers. The media guidance application may arrange, format, or otherwise visually distinguish the indicators based on the associated scores, as described further below.

In some embodiments, the media guidance application may determine a format that each media asset provider supports and may format the request appropriately. Specifically, the media guidance application may determine, for a first media asset provider of the plurality of media asset providers, a supported format for receiving characteristics. For example, the media guidance application may retrieve a template for the first media asset provider including indications of how to format the plurality of characteristics and/or other information such that the first media asset provider may properly process the information. The media guidance application may generate a request for the first media asset provider of the plurality of media asset providers, where the request includes the plurality of characteristics formatted in the supported format for the first media asset provider. For example, upon determining the supported format (e.g., based on retrieving a template), the media guidance application may generate a request to transmit, in the supported format, to the first media asset provider. Continuing with this example, the media guidance application may populate a retrieved template with the appropriate values in the appropriate fields. The media guidance application may transmit, to the first media asset provider, the request formatted in the supported format.

In some embodiments, the media guidance application may determine the plurality of media asset providers to transmit the plurality of characteristics to based on which media asset providers the user subscribes to. Specifically, the media guidance application may determine, based on subscription data associated with the user, that the user subscribes to each of the plurality of media asset providers. For example, the media guidance application may retrieve a data structure including media asset providers that the user subscribes to. As a specific example, the data structure may be a list containing identifiers of media asset providers that the user has stored passwords for. As another example, the data structure may be a list containing identifiers of media asset providers that the user has explicitly indicated that he or she subscribes to (e.g., via input from a user input interface). The media guidance application may transmit the plurality of characteristics to media asset providers that the user subscribes to and not to media asset providers that the user is not subscribed to. Specifically, the media guidance application may, in response to determining that the user subscribes to each of the plurality of media asset providers, transmit the plurality of characteristics associated with the user to each of the plurality of media asset providers without transmitting the plurality of characteristics to other media asset providers. For example, the media guidance application may, by transmitting the plurality of characteristics to media asset providers that the user subscribes to without performing the transmission to media asset providers that the user does not subscribe to, avoid transmitting and receiving unnecessary data as the user cannot access media assets from those providers.

In some embodiments, the media guidance application may determine that a media asset provider supports a set of characteristics and may transmit those characteristics to the media asset provider without transmitting the characteristics that are not supported by the media asset provider. This may allow the process to operate more efficiently because the media asset provider does not have to process and receive data for characteristics that are not supported, thus returning results to the media guidance application quicker. Specifically, the media guidance application may transmit a request to a first media asset provider of the plurality of media asset providers for a set of identifiers of characteristics that the first media asset provider supports. For example, the media guidance application may transmit a request to the media asset provider for a list or other data structure that contains characteristics that the media asset provider supports. The media guidance application may receive, from the first media asset provider, the set of identifiers of characteristics that the first media asset provider supports. For example, the media guidance application may receive a list or other data structure containing identifiers (e.g., “actor”) of characteristics that the media asset provider supports (e.g., that the media asset provider will be able to compare with metadata). The media guidance application may select, for inclusion in the first plurality of characteristics, characteristics associated with the user that are also associated with the set of identifiers. For example, the media guidance application may compare the identifiers of characteristics received from the media asset provider with stored characteristics associated with the user (e.g., that the user's favorite actor is Tom Cruise). Continuing with this example, the media guidance application may determine matches between the received identifiers and stored characteristics and select those characteristics that match for transmission to the media asset provider. The media guidance application may transmit, to the first media asset provider, the plurality of characteristics. For example, the media guidance application may transmit a request to the media asset provider containing the characteristics that the media asset provider supports.

In some embodiments, the media guidance application may create a data structure for each media asset from each media asset provider when extracting information from the media asset preference data. Specifically, the media guidance application may generate a data structure for a first media asset from a first media asset provider, wherein the data structure comprises a field for each characteristic. For example, the media guidance application may generate a list, array, or another suitable data structure for a media asset referenced in the media asset preference data. The media guidance application may extract, from an indication associated with the first media asset from the first media asset provider, a value for whether the corresponding characteristic matches the metadata associated with the first media asset. For example, the media guidance application may retrieve a value from the media asset preference data (e.g., a Boolean value) that indicates whether a particular characteristic (e.g., actor) matches metadata associated with the media asset. The media guidance application may store the extracted value in a corresponding field of the data structure. For example, the media guidance application may store the value in a field of the data structure that corresponds to the same characteristic. As a specific example, if the extracted data is a Boolean value that is set to “true” for the characteristic “actor,” then the media guidance application may store a Boolean value that is set to “true” in a field of the data structure for the actor characteristic.

In some embodiments, the media guidance application may, when calculating probabilities that the user will consume media assets, factor into the calculation characteristics that are common between media asset providers without factoring in characteristics that are not common between media asset providers. Specifically, the media guidance application may determine, from the media asset preference data, that a first media asset provider of the plurality of media asset providers supports a first plurality of characteristics and a second media asset provider of the plurality of media asset providers supports a second plurality of characteristics. For example, the media guidance application may determine identifiers of characteristics that the first media asset provider supports and identifiers of characteristics that the second media asset provider supports. The media guidance application may determine the identifiers by retrieving an identifier for every characteristic associated with a single media asset from each provider (e.g., since the same characteristics may be supported with every media asset from a given media asset provider, the media guidance application need not look at data associated with every media asset). Alternatively or additionally, the media guidance application may determine the identifiers of characteristics that were supported by transmitting a query to the media asset provider and receiving the identifiers as a response (e.g., in a data structure).

The media guidance application may determine a set of characteristics that are included in both the first plurality of characteristics and the second plurality of characteristics. For example, if one provider supports characteristics for actor, genre, and director, and the other provider supports characteristics for actor and director only, the media guidance application may determine that actor and director were used by both providers, but genre was not. Thus, whether the media guidance application determines a match for the actor and director characteristics with each media asset may be used when calculating the probability, but genre may not be factored into the probability calculation. The media guidance application may determine, for each media asset from the first media asset provider and the second media asset provider based on the amount of characteristics in the set of characteristics that match, the probability that the user will consume each respective media asset. For example, the media guidance application may use the characteristics in the set of characteristics when calculating the probability to ensure that the same number of characteristics is used from different providers, some of which may have provided additional matches that may skew the probability calculation.

In some embodiments, the media guidance application may transmit multiple values for a characteristic (e.g., multiple favorite actors of the user) and weigh the number of matches when determining the probability. Specifically, the media guidance application may determine that a first characteristic of the plurality of characteristics has multiple values. For example, the media guidance application may determine that a particular characteristic has multiple associated values for the user. As a specific example, the media guidance application may determine that the user has five favorite actors that are part of an “actor” characteristic, and may transmit all five actors to the plurality of media asset providers to provide accurate analysis of whether a user is likely to consume media assets. The media guidance application may determine how many of the values matched metadata of a media asset based on a stored indication that multiple values were transmitted for a particular characteristic (e.g., if three favorite actors are transmitted an indication is stored in a data structure).

Specifically, the media guidance application may search, in the media asset preference data associated with the first media asset provider, for a field that corresponds to a first characteristic of the first media asset. For example, the media guidance application may determine a field in a data structure that is associated with a particular characteristic, such as “actor.” As a specific example, the media guidance application may determine the field based on an identifier in an associated field (e.g., the string “Actor”). The media guidance application may extract, from the field, a number of the multiple values that match metadata associated with the first media asset. For example, the media guidance application may retrieve a stored value (e.g., an integer) indicating the number of the transmitted values that matched metadata for a media asset. As a specific example, if the user has an indicated a preference for both “Tom Cruise” and “Emily Blunt” for the “actor” characteristic, then the media guidance application may extract a value of “2” from a field associated with the number of matches for the actor category for the movie “Edge of Tomorrow” because both actors are in the movie. The media guidance application may calculate a sum of the probability that the user will consume the first media asset and the number of multiple values. For example, the media guidance application may add to the probability calculated based on whether other characteristics matched a probability associated with the number of multiple matches of the first characteristic with the media asset. As a specific example, if the calculated probability for a single match of the first characteristic is 0.1 and the calculated probability for the other characteristics is 0.5, then the media guidance application may determine a total probability of 0.7 for the likelihood that the user will consume the media asset if there are two matches of the first characteristic.

In some embodiments, the media guidance application may factor into the probability calculation whether the user has previously viewed a media asset. Specifically, the media guidance application may retrieve a viewing history associated with the user. For example, the media guidance application may retrieve the viewing history from local storage or a remote server. The viewing history may be a data structure storing a plurality of identifiers of media assets consumed by the user. The media guidance application may determine whether a media asset in the viewing history matches a first media asset from a first media asset provider of the plurality of media asset providers. For example, the media guidance application may compare an identifier of a media asset in the media asset preference data with identifiers of media assets in the viewing history (e.g., based on comparing characters of the identifiers).

Continuing with the previous example, the media guidance application may determine a match if the characters of the identifiers match, or if a threshold amount of the characters match. Additionally or alternatively, the media guidance application may examine additional data related to the media asset in the viewing history, such as when the media asset was consumed and how much was consumed. For example, if the media guidance application determines that a media asset is part of the viewing history, but was viewed longer than a threshold time ago (e.g., 1 year) or less than a threshold amount (e.g., 10%), a match may not be determined. The media guidance application, in response to determining that the media asset in the viewing history matches the first media asset, may assign a probability of zero to the first media asset. For example, upon determining that the user has already consumed a media asset, the media guidance application may assign a probability of zero to the media asset regardless of the amount of characteristics that matched metadata associated with the media asset, as the user is unlikely to consume the media asset again.

In some embodiments, the media guidance application may determine that a first score for a first media asset provider is greater than a second score for a second media asset provider and distinguish a first indicator for the first media asset provider from a second indicator for the second media asset provider. For example, in response to determining that the first score is greater than the second score, the media guidance application may generate for display the first indicator of a first size that is larger than the second indicator. As a specific example, the media guidance application may generate the first indicator twice as large as the second indicator to draw attention to the first indicator. In some embodiments, the difference in size may be directly proportional to the difference between the first and second scores.

As another example, in response to determining that the first score is greater than the second score, the media guidance application may generate for display the first indicator with a first background color indicating that the first score is greater than the second score and the second indicator with a second background color indicating that the second score is less than the first score. As a specific example, the media guidance application may map the scores to particular colors to generate for display as background colors. The mapping may be based on a stop-light color scheme, where a green background color correlates to a relatively higher ranking and red correlates to a relative lower rating. Thus, the media guidance application may generate for display the first indicator with a green background color and the second indicator with a red background color because the first score is greater than the second score.

As another example, in response to determining that the first score is greater than the second score, the media guidance application may generate for display the first indicator in a first position on a screen and the second indicator in a second position on the screen, where the first position is more prominent than the second position. As a specific example, the media guidance application may generate for display the first indicator near the top of the display screen and the second indicator below the first indicator to indicate the difference in scores. As another example, the media guidance application may generate for display the first score with the first indicator and the second score with the second indicator. As a specific example, the media guidance application may generate for display the numeric score associated with each media asset provider as part of the indicator. Alternatively or additionally, the media guidance application may generate for display a ranking associated with the media asset providers as part of the indicators.

In some embodiments, the media guidance application may present supplemental content associated with a media asset provider if the user does not subscribe to the media asset provider and it has the highest score. Specifically, the media guidance application may determine, based on the scores for each media asset provider of the plurality of media asset providers, that the user does not subscribe to a first media asset provider with a highest score. For example, the media guidance application may store the scores associated with the plurality of media asset providers and determine (e.g., based on a sorting algorithm) the media asset provider that has the highest associated score. The media guidance application may compare an identifier of the media asset provider with subscriptions data associated with the user, as described above, to determine whether the user subscribes to the media asset provider. The media guidance application may, in response to determining that the user does not currently subscribe to the first media asset provider with the highest score, generate for display supplemental content associated with the media asset provider. For example, the media guidance application may generate for display a preview (e.g., a trailer or other video clip) of some of the media assets available from the first media asset provider to entice the user to subscribe. As another example, the media guidance application may determine media assets that are only available from the first media asset provider and generate for display identifiers of the media assets and an indication that they are only available from the first media asset provider. In some embodiments, the media guidance application may determine media assets that are available from the first media asset provider and are not available from any other media asset provider above a threshold ranking (e.g., a media asset is only available from the first media asset provider and not from any of the other top five ranked media asset providers). The media guidance application may generate for display identifiers of the media assets and an indication that none of the other top ranked media asset providers provide those media assets.

It should be noted the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a data structure with media asset preference data received from one or more media asset providers, in accordance with some embodiments of the disclosure;

FIG. 2 shows an illustrative example of a data structure for a media asset extracted from media asset preference data, in accordance with some embodiments of the disclosure;

FIG. 3 shows an illustrative example of a data structure with scores for media asset providers, in accordance with some embodiments of the disclosure;

FIG. 4 shows an illustrative example of a display screen with indicators for media asset providers, in accordance with some embodiments of the disclosure;

FIG. 5 shows an illustrative example of a display screen for use in accessing media content in accordance with some embodiments of the disclosure;

FIG. 6 shows another illustrative example of a display screen for use in accessing media content in accordance with some embodiments of the disclosure;

FIG. 7 is a block diagram of an illustrative user equipment device in accordance with some embodiments of the disclosure;

FIG. 8 is a block diagram of an illustrative media system in accordance with some embodiments of the disclosure;

FIG. 9 is a flowchart of illustrative actions for recommending a provider for media asset consumption, in accordance with some embodiments of the disclosure;

FIG. 10 is another flowchart of illustrative actions for recommending a provider for media asset consumption, in accordance with some embodiments of the disclosure;

FIG. 11 is a flowchart of illustrative actions for determining which media asset providers to transmit a request to, in accordance with some embodiments of the disclosure;

FIG. 12 is a flowchart of illustrative actions for assigning a probability that a user will consume each media asset received from a media asset provider, in accordance with some embodiments of the disclosure; and

FIG. 13 is a flowchart of illustrative actions for determining an overlap between characteristics supported by two media asset providers, in accordance with some embodiments of the disclosure.

### DETAILED DESCRIPTION

Systems and methods are described for recommending a media asset provider to a user based on the amount of media assets that the user is likely to enjoy consuming. For example, characteristics associated with the user (e.g., favorite actors, genres, studios, etc.) may be transmitted, from the user's device, to multiple media asset providers. Each media asset provider may compare the transmitted characteristics with metadata of each media asset (e.g., an actor in the media asset) that is available from the media asset provider and transmit the results of the comparison to the device. The results may include a probability that a user will consume each media asset available from a media asset provider. Based on the received results (e.g., the probabilities), an amount of media assets from each media asset provider that the user is likely to consume is determined. Indicators for the media asset providers may be differentiated based on the amount of media assets from each media asset provider that the user is likely to consume (e.g., the media asset provider with the most media assets that the user is likely to consume is displayed in a larger font).

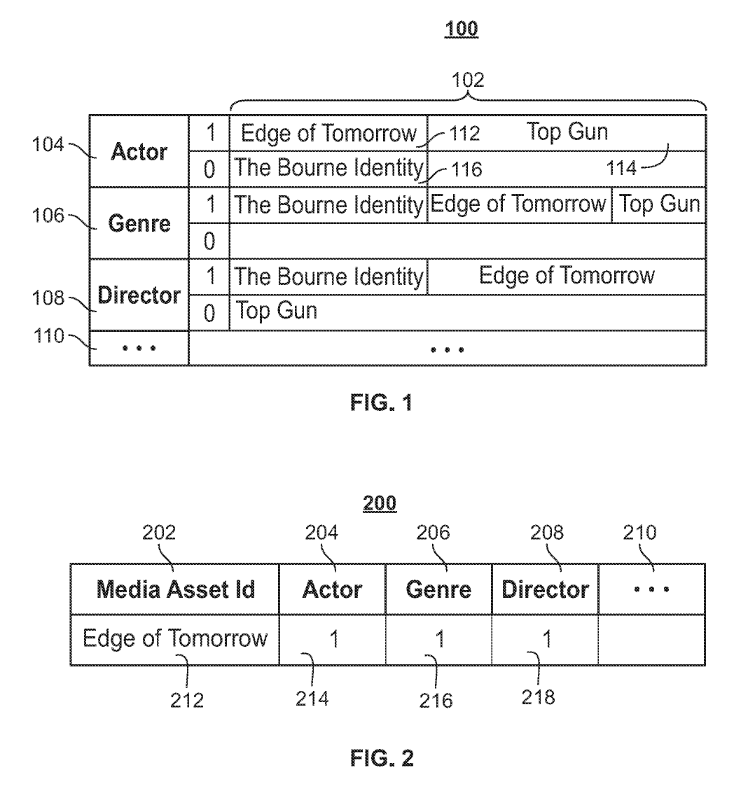

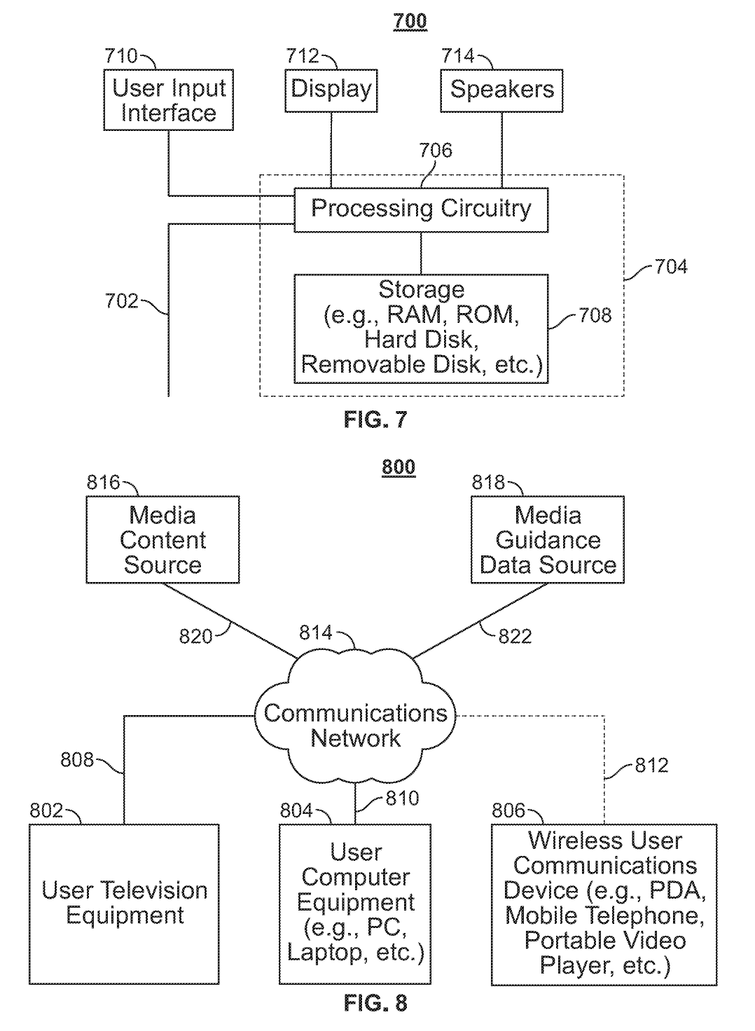

FIG. 1 shows an illustrative example of a data structure with media asset preference data received from one or more media asset providers, in accordance with some embodiments of the disclosure. For example, data structure 100 may be organized as a table containing media asset identifiers 102 for each media asset that was received from one or more sources (e.g., media asset identifiers 112, 114, and 116), where each identifier is placed in a row indicating whether user characteristics (e.g., for the user's favorite “actor,” “genre,” and/or “director”) match metadata of the media asset (e.g., characteristics 104, 106, and 108 are associated with values in data structure 100 for each of media asset identifiers 102). As a specific example, each characteristic (e.g., characteristic 104) may be associated with two lists in data structure 100, one containing identifiers of media assets that match the characteristic of the user (e.g., metadata of media asset 112 matches characteristic 104) and one containing identifiers of media assets that do not match the characteristics of the user (e.g., metadata of media asset 116 does not match characteristic 104). Data structure 100 may contain additional characteristics 110. Data structure 100 may be stored in storage (e.g., storage 708) of one or more user equipment (e.g., any of the user equipment listed in FIGS. 7-8), or remotely at a media guidance data source (e.g., media guidance data source 818) accessible via a communications network (e.g., communications network 814). A media guidance application may be executed by one or more user equipment (e.g., any of the user equipment listed in FIGS. 7-8) to receive, store, and/or process data structure 100 received from one or more media asset providers.

In some embodiments, the media guidance application may recommend a media asset provider of a plurality of media asset providers to a user based on how many media assets available from the media asset provider the user is likely to consume. Specifically, the media guidance application may transmit, to each of a plurality of media asset providers, a plurality of characteristics associated with a user. For example, the media guidance application may retrieve stored user preferences for particular actors, directors, genres, or any other person or attribute associated with media assets as the plurality of characteristics (e.g., characteristics 104, 106, 108, and 110). The stored user preferences may be explicitly set by the user (e.g., in a favorites screen) or may be determined from a viewing history associated with the user. As a specific example, if a user has consumed multiple movies starring Tom Cruise, the media guidance application may determine that Tom Cruise is a favorite actor of the user (e.g., characteristic 104). The media guidance application may determine which media asset providers to transmit the plurality of characteristics to and, in some embodiments, customize the transmission based on characteristics that each media asset provider supports (e.g., characteristics 104, 106, and 108 may be supported but some of additional characteristics 110 may not be), as discussed further below.

The media guidance application may receive a data set from each media asset provider with data describing how or to what degree each media asset available from each media asset provider matches the set of characteristics that was transmitted. The media guidance application may store the received data in a data structure (e.g., data structure 100). Specifically, the media guidance application may receive, from each media asset provider of the plurality of media asset providers, media asset preference data, where the media asset preference data includes, for each media asset available from each respective media asset provider, an indication of whether each of the plurality of characteristics matches metadata associated with each respective media asset. For example, the media guidance application may receive a list, array, markup language document, or any other suitable data structure containing the media asset preference data. The media asset preference data may be organized such that a first plurality of fields identify media assets (e.g., media asset identifiers 102), a second plurality of fields identify characteristics (e.g., characteristics 104, 106, and 108), and a third plurality of fields store an indication (e.g., each row in data structure 100 may correspond to a Boolean value for a particular characteristic) of whether the characteristic matches metadata associated with a particular media asset. The media asset preference data may also contain additional fields (e.g., additional characteristics 110) indicating how many values associated with a characteristic matches metadata associated with a media asset. For example, the user may have three favorite actors. In this situation, the media asset preference data, in addition to storing an indication of a match for the “actor” characteristic, may also store the number of matches that were found (e.g., whether multiple actors of the three favorite actors are in a movie). The media guidance application may utilize this information to assign a higher probability that the user will consume the media asset (e.g., corresponding to media asset identifier 114).

In some embodiments, the media guidance application may determine a format that each media asset provider supports and may format the request appropriately. Specifically, the media guidance application may determine, for a first media asset provider of the plurality of media asset providers, a supported format for receiving characteristics (e.g., characteristics 104, 106, and 108). For example, the media guidance application may retrieve a template stored locally in storage or at a remote server for the first media asset provider. The template may include indications of how to format the plurality of characteristics (e.g., characteristics 104, 106, and 108) and/or other information such that the first media asset provider may properly process the information. The media guidance application may generate a request for the first media asset provider of the plurality of media asset providers, where the request includes the plurality of characteristics (e.g., characteristics 104, 106, and 108) formatted in the supported format for the first media asset provider. For example, upon determining the supported format (e.g., based on retrieving a template), the media guidance application may generate a request to transmit, in the supported format, to the first media asset provider. Continuing with this example, the media guidance application may populate a retrieved template with the appropriate values in the appropriate fields. As a specific example, the media guidance application may determine that a field of a table should be populated with an identifier of the user's favorite actor and may add the identifier to the field. The media guidance application may transmit, to the first media asset provider, the request formatted in the supported format. For example, the media guidance application may interface with an application programming interface (API) to transmit the request to the first media asset provider via a communications network.

In some embodiments, the media guidance application may identify the plurality of media asset providers to transmit the plurality of characteristics to based on which media asset providers the user subscribes to. Specifically, the media guidance application may determine, based on subscription data associated with the user, that the user subscribes to each of the plurality of media asset providers. For example, the media guidance application may retrieve, either from storage or a remote server, a data structure including media asset providers that the user subscribes to. As a specific example, the data structure may be a list containing identifiers of media asset providers that the user has stored passwords for. As another example, the data structure may be a list containing identifiers of media asset providers that the user has explicitly indicated that he or she subscribes to (e.g., via input from a user input interface). The media guidance application may transmit the plurality of characteristics (e.g., characteristics 104, 106, and 108) to media asset providers that the user subscribes to and not to media asset providers that the user is not subscribed to. Specifically, the media guidance application may, in response to determining that the user subscribes to each of the plurality of media asset providers, transmit the plurality of characteristics (e.g., characteristics 104, 106, and 108) associated with the user to each of the plurality of media asset providers without transmitting the plurality of characteristics to other media asset providers. For example, the media guidance application may, by transmitting the plurality of characteristics (e.g., characteristics 104, 106, and 108) to media asset providers that the user subscribes to without performing the transmission to media asset providers that the user does not subscribe to, avoid transmitting and receiving unnecessary data as the user cannot access media assets from those providers.

In some embodiments, the media guidance application may determine that a media asset provider supports a set of characteristics (e.g., characteristics 104 and 106 are supported, but not characteristic 108) and may transmit those characteristics to the media asset provider without transmitting the characteristics that are not supported by the media asset provider. This may allow the process to operate more efficiently because the media asset provider does not have to process and receive data for characteristics that are not supported (e.g., characteristic 108), thus returning results to the media guidance application quicker (e.g., since only characteristics 104 and 106 are supported by the provider).

Specifically, the media guidance application may transmit a request to a first media asset provider of the plurality of media asset providers for a set of identifiers of characteristics (e.g., identifiers of characteristics 104 and 106) that the first media asset provider supports. For example, the media guidance application may transmit a request to the media asset provider for a list or other data structure that contains characteristics that the media asset provider supports. The media guidance application may receive, from the first media asset provider, the set of identifiers of characteristics that the first media asset provider supports. For example, the media guidance application may receive a list or other data structure containing identifiers (e.g., identifiers of characteristics 104 and 106) of characteristics that the media asset provider supports (e.g., that the media asset provider will be able to compare with metadata). The media guidance application may select, for inclusion in the first plurality of characteristics, characteristics associated with the user that are also associated with the set of identifiers. For example, the media guidance application may compare the identifiers of characteristics received from the media asset provider (e.g., identifiers of characteristics 104 and 106) with stored characteristics associated with the user (e.g., the user's favorite actor(s) and genre(s)). Continuing with this example, the media guidance application may determine matches between the received identifiers (e.g., identifiers of characteristics 104 and 106) and stored characteristics and select those characteristics that match for transmission to the media asset provider. The media guidance application may transmit, to the first media asset provider, the plurality of characteristics (e.g., the user's preferences for characteristics 104 and 106). For example, the media guidance application may transmit a request to the media asset provider containing the characteristics (e.g., the user's preferences for characteristics 104 and 106) that the media asset provider supports.

FIG. 2 shows an illustrative example of a data structure for a media asset extracted from media asset preference data, in accordance with some embodiments of the disclosure. For example, the media guidance application may extract a media asset identifier from data structure 100 (e.g., media asset identifier 114 in FIG. 1) and generate data structure 200. Data structure 200 may be organized as a table containing one or more media asset identifiers 202 and indications for whether each characteristic (e.g., characteristics 204, 206 and 208) in the media asset preference data received from a media asset provider of the media asset match metadata associated with the media asset (e.g., field 214 corresponds to whether metadata of a media asset identified by media asset identifier 212 matches characteristic 204). The media guidance application may add the appropriate indication to each field of data structure 200 (e.g., field 214, 216, and 218) depending on whether a match was determined. When generating data structure 200, the media guidance application may format the media asset preference data received from a media asset provider into a common format (e.g., the indications stored in fields 214, 216, and 218 for media asset identifier 212 should be the same type (such as Boolean) as for all other media asset identifiers for easier comparison by the media guidance application). Data structure 200 may contain additional characteristics 210 that are associated with media asset identifier 212. Data structure 200 may be stored in storage (e.g., storage 708) of one or more user equipment (e.g., any of the user equipment listed in FIGS. 7-8), or remotely at a media guidance data source (e.g., media guidance data source 818) accessible via a communications network (e.g., communications network 814). A media guidance application may be executed by one or more user equipment (e.g., any of the user equipment listed in FIGS. 7-8) to generate data structure 200.

In some embodiments, the media guidance application may extract, from the media asset preference data (e.g., as stored in data structure 100) for each media asset, a plurality of indications, where each indication of the plurality of indications indicates whether a characteristic of the plurality of characteristics matches metadata associated with a corresponding media asset (e.g., media asset identifier 212). For example, the media guidance application may process the media asset preference data (e.g., as stored in data structure 100) to group indications that refer to the same media asset (e.g., the data for media asset identifier 114 in FIG. 1 is extracted into data structure 200). In some embodiments, the media guidance application may also standardize the indications from different media asset providers during extraction from the media asset preference data. For example, if one media asset provider transmits binary indications about whether a match was determined and another media asset provider transmits indications on a scale of 1-10, the media guidance application may convert the indications to a common format in order to more easily assign probabilities to each media asset that the user will consume each media asset.

The media guidance application may determine, based on a respective plurality of indications (e.g., fields 214, 216, and 218) for each media asset (e.g., such as data structure 200 for the media asset associated with media asset identifier 212), an amount of characteristics that match metadata associated with the corresponding media asset. For example, the media guidance application may determine whether a characteristic (e.g., characteristic 204) matches metadata of a media asset (e.g., media asset identifier 212) based on the received media asset preference data (e.g., a value stored in data structure 100). In some embodiments, a particular characteristic (e.g., characteristic 204) may be associated with a Boolean value, set to either true or false, for a particular media asset from a particular media asset provider. The media guidance application may determine a match between the characteristic (e.g., characteristic 204) and the metadata based on the true or false value without further processing. In some embodiments, a particular characteristic (e.g., characteristic 206) may be associated with a numeric value. The media guidance application may utilize a rule set to determine whether a match between the characteristic (e.g., characteristic 206) and the metadata was determined based on the numeric value. As a specific example, if the media guidance application extracts a value of “0.5” (e.g., indicating a 50% match between a given characteristic and metadata of a media asset), then the media guidance application may determine whether a 50% match should be considered a match based on a rule set. In other words, the media guidance application may determine whether the value is above or below a threshold to be considered a binary match (e.g., above 70% is a match, but below is not a match). The media guidance application may sum the number of matches between the plurality of characteristics (e.g., characteristics 204, 206 and 208) and metadata of a given media asset to calculate the amount of characteristics that matched. In some embodiments, the media guidance application may determine whether multiple values for a given characteristic match and factor this into calculation of the amount, as discussed further below. For example, if two of the user's favorite actors (e.g., characteristic 204) are in a media asset, then the media guidance application may determine two separate matches when calculating the amount.

The media guidance application may determine, for each media asset (e.g., such as the media asset identified by media asset identifier 212) based on the amount of characteristics (e.g., characteristics 204, 206, and 208) that match the metadata, a probability that the user will consume each respective media asset. As an example, the media guidance application may determine that the percentage of characteristics that match out of the total number of the plurality of characteristics is the probability. As a specific example, if 3 out of 3 characteristics match (e.g., since field 214, 216, and 218 all store a Boolean value set to “true”) for a media asset (e.g., media asset identifier 212), the media guidance application may assign 100% as the probability for the media asset. As another example, the media guidance application may weigh certain factors higher or lower (e.g., based on user preferences). In this example, if a user has a strong preference for his or her favorite actors (e.g., characteristic 204) being in media assets, but less of a preference for the genre (e.g., characteristic 206), then the media guidance application may assign a media asset matching only the actor characteristic a higher probability than another media asset matching only the genre characteristic.

In some embodiments, the media guidance application may create a data structure for each media asset from each media asset provider when extracting information from the media asset preference data (e.g., as stored in data structure 100). Specifically, the media guidance application may generate a data structure (e.g., data structure 200) for a first media asset (e.g., identified by media asset identifier 212) from a first media asset provider, wherein the data structure comprises a field for each characteristic. For example, the media guidance application may generate a list, array, or another suitable data structure for a media asset referenced in the media asset preference data. The media guidance application may extract, from an indication associated with the first media asset from the first media asset provider, a value for whether the corresponding characteristic matches the metadata associated with the first media asset (e.g., a value from data structure 100). For example, the media guidance application may retrieve a value from the media asset preference data (e.g., a Boolean value) that indicates whether a particular characteristic (e.g., characteristic 104) matches metadata associated with the media asset (e.g., identified by media asset identifier 212 which identifies the same media asset as media asset identifier 114). The media guidance application may store the extracted value in a corresponding field of the data structure (e.g., data structure 200). For example, the media guidance application may store the value in a field (e.g., field 214) of the data structure (e.g., data structure 200) that corresponds to the same characteristic (e.g., characteristic 204 corresponds to characteristic 104). As a specific example, if the extracted data is a Boolean value that is set to “true” for the characteristic “actor,” then the media guidance application may store a Boolean value that is set to “true” in a field (e.g., field 214) of the data structure (e.g., data structure 200) for the actor characteristic (e.g., characteristic 204).

In some embodiments, the media guidance application may, when calculating probabilities that the user will consume media assets, factor into the calculation characteristics that are common between media asset providers (e.g., characteristics 204 and 206 may be common) without factoring in characteristics that are not common between media asset providers (e.g., only some providers compare characteristic 208 with metadata). Specifically, the media guidance application may determine, from the media asset preference data, that a first media asset provider of the plurality of media asset providers supports a first plurality of characteristics and a second media asset provider of the plurality of media asset providers supports a second plurality of characteristics. For example, the media guidance application may determine identifiers of characteristics (e.g., characteristics 204 and 206) that the first media asset provider supports and identifiers of characteristics (e.g., characteristics 204, 206, and 208) that the second media asset provider supports. The media guidance application may determine the identifiers by retrieving an identifier for every characteristic (e.g., characteristics 204) associated with a single media asset (e.g., media asset identifier 212) from each provider (e.g., since the same characteristics may be supported by every media asset from a given media asset provider, the media guidance application need not look at data associated with every media asset). Alternatively or additionally, the media guidance application may determine the identifiers of characteristics (e.g., characteristics 204 and 206) that were supported by a media asset provider by transmitting a query to the media asset provider and receiving the identifiers as a response (e.g., in a data structure).

The media guidance application may determine a set of characteristics that are included in both the first plurality of characteristics and the second plurality of characteristics. For example, if one provider supports characteristics for actor, genre, and director, (e.g., characteristics 204, 206, and 208) and the other provider supports characteristics for actor and director only (e.g., characteristics 204 and 208), then the media guidance application may determine that actor and director were used by both providers, but genre was not. Thus, whether the media guidance application determines a match for the actor and director characteristics with each media asset (e.g., as indicated in data structure 200 for media asset identifier 212) may be used when calculating the probability, but genre (e.g., the value in field 216) may not be factored into the probability calculation. The media guidance application may determine, for each media asset from the first media asset provider and the second media asset provider based on the amount of characteristics in the set of characteristics that match, the probability that the user will consume each respective media asset. For example, the media guidance application may use only the characteristics in the set of characteristics (e.g., characteristics 204 and 208) when calculating the probability to ensure that the same number of characteristics is used from different providers, some of which may have provided additional matches that may skew the probability calculation.

In some embodiments, the media guidance application may transmit multiple values for a characteristic (e.g., multiple favorite actors of the user) and weigh the number of matches when determining the probability. Specifically, the media guidance application may determine that a first characteristic (e.g., characteristic 204) of the plurality of characteristics has multiple values. For example, the media guidance application may determine that a particular characteristic (e.g., characteristic 204) has multiple associated values for the user. As a specific example, the media guidance application may determine that the user has five favorite actors that are part of an “actor” characteristic (e.g., characteristic 204), and may transmit all five actors to the plurality of media asset providers to provide accurate analysis of whether a user is likely to consume media assets. Based on knowledge (e.g., a stored indication that multiple values were transmitted for a category) the media guidance application may determine how many of the values matched metadata of a media asset (e.g., such as the media asset identified by media asset identifier 212).

The media guidance application may search, in the media asset preference data (e.g., as stored in data structure 100) associated with the first media asset provider, for a field that corresponds to a first characteristic (e.g., characteristic 204) of the first media asset (e.g., such as the media asset identified by media asset identifier 212). For example, the media guidance application may determine a field in a data structure (e.g., in data structure 100) that is associated with a particular characteristic (e.g., characteristic 104), such as “actor.” As a specific example, the media guidance application may determine the field (e.g., another field associated with characteristic 104 in data structure 100) based on an identifier in an associated field (e.g., the string “Actor”). The media guidance application may extract, from the field, a number of the multiple values that match metadata associated with the first media asset. For example, the media guidance application may retrieve a stored value (e.g., an integer) indicating the number of the transmitted values that matched metadata for a media asset. As a specific example, if the user has an indicated a preference for both “Tom Cruise” and “Emily Blunt” for the “actor” characteristic (e.g., characteristic 104 which corresponds to characteristic 204), then the media guidance application may extract a value of “2” from a field associated with the number of matches for the actor category for the movie “Edge of Tomorrow” because both actors are in the movie. The media guidance application may store the extracted value from the media asset preference data (e.g., data structure 100) in a field of media asset specific metadata (e.g., data structure 200). The media guidance application may calculate a sum of the probability that the user will consume the first media asset and the number of multiple values. For example, the media guidance application may add to the probability calculated based on whether other characteristics (e.g., characteristics 206 and 208) matched a probability associated with the number of multiple matches of the first characteristic with the media asset (e.g., how many different matches with characteristic 204 were found). As a specific example, if the calculated probability for a single match of the first characteristic is 0.1 and the calculated probability for the other characteristics is 0.5, then the media guidance application may determine a total probability of 0.7 for the likelihood that the user will consume the media asset (e.g., identified by media asset identifier 212) if there are two matches of the first characteristic (e.g., characteristic 204).

In some embodiments, the media guidance application may factor into the probability calculation whether the user has previously viewed a media asset (e.g., identified by media asset identifier 212). Specifically, the media guidance application may retrieve a viewing history associated with the user. For example, the media guidance application may retrieve the viewing history from local storage or a remote server. The viewing history may be a data structure storing a plurality of identifiers of media assets consumed by the user. The media guidance application may determine whether a media asset in the viewing history matches a first media asset (e.g., identified by media asset identifier 212) from a first media asset provider of the plurality of media asset providers. For example, the media guidance application may compare an identifier of a media asset in the media asset preference data with identifiers of media assets in the viewing history (e.g., based on comparing characters of the identifiers).

Continuing with the previous example, the media guidance application may determine a match if the characters of the identifiers match, or if a threshold amount of the characters match. Additionally or alternatively, the media guidance application may examine additional data related to the media asset in the viewing history, such as when the media asset was consumed and how much was consumed. For example, if the media guidance application determines that a media asset (e.g., identified by media asset identifier 212) is part of the viewing history, but was viewed longer than a threshold time ago (e.g., 1 year) or less than a threshold amount (e.g., 10%), then a match may not be determined. The media guidance application, in response to determining that the media asset in the viewing history matches the first media asset (e.g., identified by media asset identifier 212), may assign a probability of zero to the first media asset. For example, upon determining that the user has already consumed a media asset (e.g., identified by media asset identifier 212), the media guidance application may assign a probability of zero to the media asset regardless of the amount of characteristics that matched metadata associated with the media asset, as the user is unlikely to consume the media asset again.

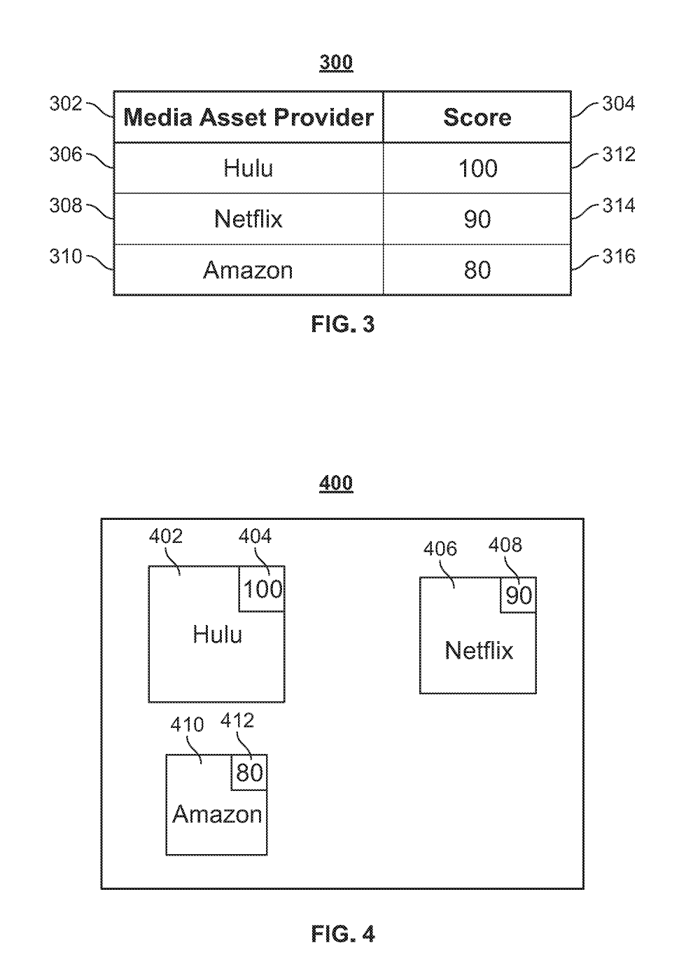

FIG. 3 shows an illustrative example of a data structure with scores for media asset providers, in accordance with some embodiments of the disclosure. For example, the media guidance application may calculate scores 304 for media asset providers 302 that media asset preference data was received from (e.g., which may be indicated by identifiers of media asset providers 302 in data structure 100). Data structure 300 may be organized as a table containing identifiers of media asset providers (e.g., media asset provider 306, 308, and 310) where each media asset provider is associated with a score in a corresponding field (e.g., scores 312, 314, and 316). Data structure 300 may be stored in storage (e.g., storage 708) of one or more user equipment (e.g., any of the user equipment listed in FIGS. 7-8), or remotely at a media guidance data source (e.g., media guidance data source 818) accessible via a communications network (e.g., communications network 814). A media guidance application may be executed by one or more user equipment (e.g., any of the user equipment listed in FIGS. 7-8) to generate data structure 300.

In some embodiments, the media guidance application may use the calculated probabilities (e.g., calculated based on the extracted media asset preference data as described above in FIG. 2) that the user will consume each media asset from a particular media asset provider to calculate an overall score for the media asset provider (e.g., score 312 for media asset provider 306). Specifically, the media guidance application may calculate, based on a plurality of probabilities associated with each respective media asset provider of the plurality of media asset providers, a score for each media asset provider of the plurality of media asset providers. For example, the media guidance application may sum the probability for every media asset from a particular media asset provider (e.g., media asset provider 306) to calculate the score (e.g., score 312) for the media asset provider. In some embodiments, the media guidance application may normalize the scores (e.g., scores 304) based on the total number of media assets available from each media asset provider (e.g., media asset providers 302), or may not normalize the scores.

In some embodiments, the media guidance application may present supplemental content associated with a media asset provider if the user does not subscribe to the media asset provider and it has the highest score (e.g., score 312 for media asset provider 306 is the highest score). Specifically, the media guidance application may determine, based on the scores (e.g., scores 304) for each media asset provider of the plurality of media asset providers (e.g., media asset providers 302), that the user does not subscribe to a first media asset provider with a highest score. For example, the media guidance application may store (e.g., in data structure 300) the scores associated with the plurality of media asset providers and determine (e.g., based on a sorting algorithm) the media asset provider (e.g., media asset provider 306) that has the highest associated score (e.g., score 312). The media guidance application may compare an identifier of the media asset provider with subscriptions data associated with the user, as described above with respect to FIG. 1, to determine whether the user subscribes to the media asset provider (e.g., media asset provider 306). The media guidance application may, in response to determining that the user does not currently subscribe to the first media asset provider with the highest score (e.g., media asset provider 306), generate for display supplemental content associated with the media asset provider. For example, the media guidance application may generate for display a preview (e.g., a trailer or other video clip) of some of the media assets available from the first media asset provider (e.g., media asset provider 306). As another example, the media guidance application may determine media assets that are only available from the first media asset provider (e.g., media asset provider 306) and generate for display identifiers of the media assets and an indication that they are only available from the first media asset provider.

FIG. 4 shows an illustrative example of a display screen with indicators for media asset providers, in accordance with some embodiments of the disclosure. For example, user equipment may execute a media guidance application which may generate display 400. Display 400 may include indicators 402, 406, and 410 corresponding to different media asset providers. Indicators 402, 406, and 410 may be generated for display such that the difference in score between the media asset providers identified by indicators 402, 406, and 410 are visually distinguishable. For example, indicator 402 may be larger in size than indicator 406, which may be larger in size than indicator 410. The difference in size may be based on the scores calculated for the media asset providers (e.g., the media asset provider associated with indicator 402 has a greater score than the media asset provider associated with indicator 406, which has a greater score than the media asset provider associated with indicator 410). Furthermore, the indicators may include the score (e.g., a number) with each indicator (e.g., scores 404, 408, and 412). Display 400 may appear on one or more user devices.

The media guidance application may generate for display indicators (e.g., graphics) for each media asset provider formatted based on the calculated scores. Specifically, the media guidance application may generate for display a first indicator (e.g., indicator 402) for a first media asset provider of the plurality of media asset providers and a second indicator (e.g., indicator 406) for a second media asset provider of the plurality of media asset providers, wherein the first indicator is visually distinguished from the second indicator based on a first score calculated for the first media asset provider and a second score calculated for the second media asset provider. For example, the media guidance application may receive a user input from the user to generate a display with indicators (e.g., indicators 402 and 406) of media asset providers. The media guidance application may arrange, format, or otherwise visually distinguish the indicators based on the associated scores, as described further below.

In some embodiments, the media guidance application may determine that a first score for a first media asset provider is greater than a second score for a second media asset provider and distinguish a first indicator (e.g., indicator 402) for the first media asset provider from a second indicator (e.g., indicator 406) for the second media asset provider. For example, in response to determining that the first score is greater than the second score, the media guidance application may generate for display the first indicator of a first size that is larger than the second indicator. As a specific example, the media guidance application may generate the first indicator (e.g., indicator 402) twice as large as the second indicator (e.g., indicator 406) to draw attention to the first indicator. In some embodiments, the difference in size may be directly proportional to the difference between the first and second scores.

As another example, in response to determining that the first score is greater than the second score, the media guidance application may generate for display the first indicator (e.g., indicator 402) with a first background color indicating that the first score is greater than the second score and the second indicator (e.g., indicator 406) with a second background color indicating that the second score is less than the first score. As a specific example, the media guidance application may map the scores to particular colors to generate for display as background colors. The mapping may be based on a stop-light color scheme, where a green background color correlates to a relatively higher ranking and red correlates to a relative lower rating. Thus, the media guidance application may generate for display the first indicator (e.g., indicator 402) with a green background color and the second indicator (e.g., indicator 406) with a red background color because the first score is greater than the second score.

As another example, in response to determining that the first score is greater than the second score, the media guidance application may generate for display the first indicator (e.g., indicator 402) in a first position on a screen and the second indicator in a second position (e.g., indicator 410) on the screen, where the first position is more prominent than the second position. As a specific example, the media guidance application may generate for display the first indicator (e.g., indicator 402) near the top of the display screen and the second indicator (e.g., indicator 410) below the first indicator to indicate the difference in scores. As another example, the media guidance application may generate for display the first score (e.g., score 404) with the first indicator (e.g., indicator 402) and the second score (e.g., score 408) with the second indicator (e.g., indicator 406). As a specific example, the media guidance application may generate for display the numeric score (e.g., score 404) associated with each media asset provider as part of the indicator. Alternatively or additionally, the media guidance application may generate for display a ranking associated with the media asset providers as part of the indicators.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), on-demand information, blogs, websites, and any other type of guidance data that is helpful for a user to navigate among and locate desired content selections.

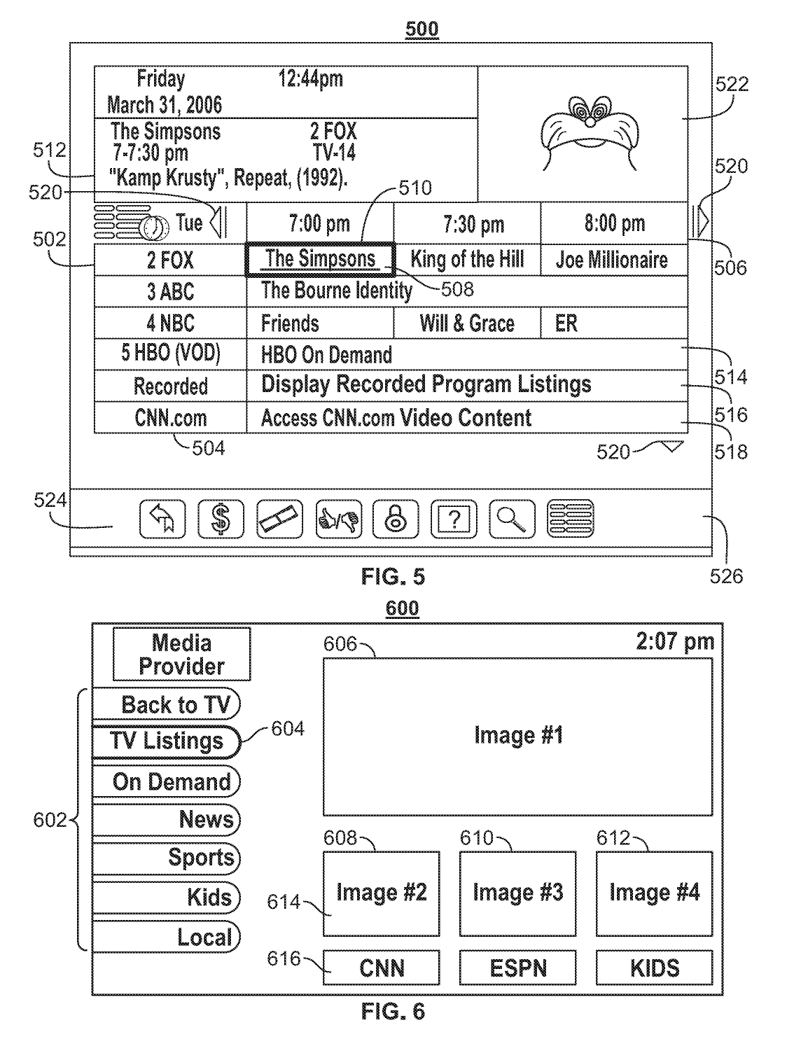

FIGS. 5-6 show illustrative display screens that may be used to provide media guidance data. The display screens shown in FIGS. 5-6 may be implemented on any suitable user equipment device or platform. While the displays of FIGS. 5-6 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 5 shows illustrative grid of a program listings display 500 arranged by time and channel that also enables access to different types of content in a single display. Display 500 may include grid 502 with: (1) a column of channel/content type identifiers 504, where each channel/content type identifier (which is a cell in the column) identifies a different channel or content type available; and (2) a row of time identifiers 506, where each time identifier (which is a cell in the row) identifies a time block of programming. Grid 502 also includes cells of program listings, such as program listing 508, where each listing provides the title of the program provided on the listing's associated channel and time. With a user input device, a user can select program listings by moving highlight region 510. Information relating to the program listing selected by highlight region 510 may be provided in program information region 512. Region 512 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc.

Internet content may include web events, such as a chat session or Webcast, or content available on-demand as streaming content or downloadable content through an Internet web site or other Internet access (e.g. FTP).

Grid 502 may provide media guidance data for non-linear programming including on-demand listing 514, recorded content listing 516, and Internet content listing 518. A display combining media guidance data for content from different types of content sources is sometimes referred to as a “mixed-media” display. Various permutations of the types of media guidance data that may be displayed that are different than display 500 may be based on user selection or guidance application definition (e.g., a display of only recorded and broadcast listings, only on-demand and broadcast listings, etc.). As illustrated, listings 514, 516, and 518 are shown as spanning the entire time block displayed in grid 502 to indicate that selection of these listings may provide access to a display dedicated to on-demand listings, recorded listings, or Internet listings, respectively. In some embodiments, listings for these content types may be included directly in grid 502. Additional media guidance data may be displayed in response to the user selecting one of the navigational icons 520. (Pressing an arrow key on a user input device may affect the display in a similar manner as selecting navigational icons 520.)

Display 500 may also include video region 522, and options region 526. Video region 522 may allow the user to view and/or preview programs that are currently available, will be available, or were available to the user. The content of video region 522 may correspond to, or be independent from, one of the listings displayed in grid 502. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Options region 526 may allow the user to access different types of content, media guidance application displays, and/or media guidance application features. Options region 526 may be part of display 500 (and other display screens described herein), or may be invoked by a user by selecting an on-screen option or pressing a dedicated or assignable button on a user input device. The selectable options within options region 526 may concern features related to program listings in grid 502 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 8. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 6. Video mosaic display 600 includes selectable options 602 for content information organized based on content type, genre, and/or other organization criteria. In display 600, television listings option 604 is selected, thus providing listings 606, 608, 610, and 612 as broadcast program listings. In display 600 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 608 may include more than one portion, including media portion 614 and text portion 616. Media portion 614 and/or text portion 616 may be selectable to view content in full-screen or to view information related to the content displayed in media portion 614 (e.g., to view listings for the channel that the video is displayed on).

The listings in display 600 are of different sizes (i.e., listing 606 is larger than listings 608, 610, and 612), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

Users may access content and the media guidance application (and its display screens described above and below) from one or more of their user equipment devices. FIG. 7 shows a generalized embodiment of illustrative user equipment device 700. More specific implementations of user equipment devices are discussed below in connection with FIG. 8. User equipment device 700 may receive content and data via input/output (hereinafter “I/O”) path 702. I/O path 702 may provide content (e.g., broadcast programming, on-demand programming, Internet content, content available over a local area network (LAN) or wide area network (WAN), and/or other content) and data to control circuitry 704, which includes processing circuitry 706 and storage 708. Control circuitry 704 may be used to send and receive commands, requests, and other suitable data using I/O path 702. I/O path 702 may connect control circuitry 704 (and specifically processing circuitry 706) to one or more communications paths (described below). I/O functions may be provided by one or more of these communications paths, but are shown as a single path in FIG. 7 to avoid overcomplicating the drawing.

Control circuitry 704 may be based on any suitable processing circuitry such as processing circuitry 706. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 704 executes instructions for a media guidance application stored in memory (i.e., storage 708). Specifically, control circuitry 704 may be instructed by the media guidance application to perform the functions discussed above and below. For example, the media guidance application may provide instructions to control circuitry 704 to generate the media guidance displays. In some implementations, any action performed by control circuitry 704 may be based on instructions received from the media guidance application.

In client-server based embodiments, control circuitry 704 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 8). In addition, communications circuitry may include circuitry that enables peer-to-peer communication of user equipment devices, or communication of user equipment devices in locations remote from each other (described in more detail below).

Memory may be an electronic storage device provided as storage 708 that is part of control circuitry 704. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 708 may be used to store various types of content described herein as well as media guidance data described above. Nonvolatile memory may also be used (e.g., to launch a boot-up routine and other instructions). Cloud-based storage, described in relation to FIG. 8, may be used to supplement storage 708 or instead of storage 708.

Control circuitry 704 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 704 may also include scaler circuitry for upconverting and downconverting content into the preferred output format of the user equipment 700. Circuitry 704 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 708 is provided as a separate device from user equipment 700, the tuning and encoding circuitry (including multiple tuners) may be associated with storage 708.

A user may send instructions to control circuitry 704 using user input interface 710. User input interface 710 may be any suitable user interface, such as a remote control, mouse, trackball, keypad, keyboard, touch screen, touchpad, stylus input, joystick, voice recognition interface, or other user input interfaces. Display 712 may be provided as a stand-alone device or integrated with other elements of user equipment device 700. For example, display 712 may be a touchscreen or touch-sensitive display. In such circumstances, user input interface 710 may be integrated with or combined with display 712. Display 712 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 712 may be HDTV-capable. In some embodiments, display 712 may be a 3D display, and the interactive media guidance application and any suitable content may be displayed in 3D. A video card or graphics card may generate the output to the display 712. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 704. The video card may be integrated with the control circuitry 704. Speakers 714 may be provided as integrated with other elements of user equipment device 700 or may be stand-alone units. The audio component of videos and other content displayed on display 712 may be played through speakers 714. In some embodiments, the audio may be distributed to a receiver (not shown), which processes and outputs the audio via speakers 714.

The guidance application may be implemented using any suitable architecture. For example, it may be a stand-alone application wholly-implemented on user equipment device 700. In such an approach, instructions of the application are stored locally (e.g., in storage 708), and data for use by the application is downloaded on a periodic basis (e.g., from an out-of-band feed, from an Internet resource, or using another suitable approach). Control circuitry 704 may retrieve instructions of the application from storage 708 and process the instructions to generate any of the displays discussed herein. Based on the processed instructions, control circuitry 704 may determine what action to perform when input is received from input interface 710. For example, movement of a cursor on a display up/down may be indicated by the processed instructions when input interface 710 indicates that an up/down button was selected.

In some embodiments, the media guidance application is a client-server based application. Data for use by a thick or thin client implemented on user equipment device 700 is retrieved on-demand by issuing requests to a server remote to the user equipment device 700. In one example of a client-server based guidance application, control circuitry 704 runs a web browser that interprets web pages provided by a remote server. For example, the remote server may store the instructions for the application in a storage device. The remote server may process the stored instructions using circuitry (e.g., control circuitry 704) and generate the displays discussed above and below. The client device may receive the displays generated by the remote server and may display the content of the displays locally on equipment device 700. This way, the processing of the instructions is performed remotely by the server while the resulting displays are provided locally on equipment device 700. Equipment device 700 may receive inputs from the user via input interface 710 and transmit those inputs to the remote server for processing and generating the corresponding displays. For example, equipment device 700 may transmit a communication to the remote server indicating that an up/down button was selected via input interface 710. The remote server may process instructions in accordance with that input and generate a display of the application corresponding to the input (e.g., a display that moves a cursor up/down). The generated display is then transmitted to equipment device 700 for presentation to the user.

In some embodiments, the media guidance application is downloaded and interpreted or otherwise run by an interpreter or virtual machine (run by control circuitry 704). In some embodiments, the guidance application may be encoded in the ETV Binary Interchange Format (EBIF), received by control circuitry 704 as part of a suitable feed, and interpreted by a user agent running on control circuitry 704. For example, the guidance application may be an EBIF application. In some embodiments, the guidance application may be defined by a series of JAVA-based files that are received and run by a local virtual machine or other suitable middleware executed by control circuitry 704. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 700 of FIG. 7 can be implemented in system 800 of FIG. 8 as user television equipment 802, user computer equipment 804, wireless user communications device 806, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 7 may not be classified solely as user television equipment 802, user computer equipment 804, or a wireless user communications device 806. For example, user television equipment 802 may, like some user computer equipment 804, be Internet-enabled allowing for access to Internet content, while user computer equipment 804 may, like some television equipment 802, include a tuner allowing for access to television programming. The media guidance application may have the same layout on various different types of user equipment or may be tailored to the display capabilities of the user equipment. For example, on user computer equipment 804, the guidance application may be provided as a web site accessed by a web browser. In another example, the guidance application may be scaled down for wireless user communications devices 806.

In system 800, there is typically more than one of each type of user equipment device but only one of each is shown in FIG. 8 to avoid overcomplicating the drawing. In addition, each user may utilize more than one type of user equipment device and also more than one of each type of user equipment device.

In some embodiments, a user equipment device (e.g., user television equipment 802, user computer equipment 804, wireless user communications device 806) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 814. Namely, user television equipment 802, user computer equipment 804, and wireless user communications device 806 are coupled to communications network 814 via communications paths 808, 810, and 812, respectively.

Communications network 814 may be one or more networks including the Internet, a mobile phone network, mobile voice or data network (e.g., a 4G or LTE network), cable network, public switched telephone network, or other types of communications network or combinations of communications networks. Paths 808, 810, and 812 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 812 is drawn with dotted lines to indicate that in the exemplary embodiment shown in FIG. 8 it is a wireless path and paths 808 and 810 are drawn as solid lines to indicate they are wired paths (although these paths may be wireless paths, if desired). Communications with the user equipment devices may be provided by one or more of these communications paths, but are shown as a single path in FIG. 8 to avoid overcomplicating the drawing.

Although communications paths are not drawn between user equipment devices, these devices may communicate directly with each other via communication paths, such as those described above in connection with paths 808, 810, and 812, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 814.

System 800 includes content source 816 and media guidance data source 818 coupled to communications network 814 via communication paths 820 and 822, respectively. Paths 820 and 822 may include any of the communication paths described above in connection with paths 808, 810, and 812. Communications with the content source 816 and media guidance data source 818 may be exchanged over one or more communications paths, but are shown as a single path in FIG. 8 to avoid overcomplicating the drawing. In addition, there may be more than one of each of content source 816 and media guidance data source 818, but only one of each is shown in FIG. 8 to avoid overcomplicating the drawing. (The different types of each of these sources are discussed below.) If desired, content source 816 and media guidance data source 818 may be integrated as one source device. Although communications between sources 816 and 818 with user equipment devices 802, 804, and 806 are shown as through communications network 814, in some embodiments, sources 816 and 818 may communicate directly with user equipment devices 802, 804, and 806 via communication paths (not shown) such as those described above in connection with paths 808, 810, and 812.

Content source 816 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 816 may be the originator of content (e.g., a television broadcaster, a Webcast provider, etc.) or may not be the originator of content (e.g., an on-demand content provider, an Internet provider of content of broadcast programs for downloading, etc.). Content source 816 may include cable sources, satellite providers, on-demand providers, Internet providers, over-the-top content providers, or other providers of content. Content source 816 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 818 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 818 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 818 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 818 may provide user equipment devices 802, 804, and 806 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 708, and executed by control circuitry 704 of a user equipment device 700. In some embodiments, media guidance applications may be client-server applications where only a client application resides on the user equipment device, and server application resides on a remote server. For example, media guidance applications may be implemented partially as a client application on control circuitry 704 of user equipment device 700 and partially on a remote server as a server application (e.g., media guidance data source 818) running on control circuitry of the remote server. When executed by control circuitry of the remote server (such as media guidance data source 818), the media guidance application may instruct the control circuitry to generate the guidance application displays and transmit the generated displays to the user equipment devices. The server application may instruct the control circuitry of the media guidance data source 818 to transmit data for storage on the user equipment. The client application may instruct control circuitry of the receiving user equipment to generate the guidance application displays.

Content and/or media guidance data delivered to user equipment devices 802, 804, and 806 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 800 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 8.

In one approach, user equipment devices may communicate with each other within a home network. User equipment devices can communicate with each other directly via short-range point-to-point communication schemes described above, via indirect paths through a hub or other similar device provided on a home network, or via communications network 814. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 816 to access content. Specifically, within a home, users of user television equipment 802 and user computer equipment 804 may access the media guidance application to navigate among and locate desirable content. Users may also access the media guidance application outside of the home using wireless user communications devices 806 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 814. These cloud resources may include one or more content sources 816 and one or more media guidance data sources 818. In addition or in the alternative, the remote computing sites may include other user equipment devices, such as user television equipment 802, user computer equipment 804, and wireless user communications device 806. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 804 or wireless user communications device 806 having content capture feature. Alternatively, the user can first transfer the content to a user equipment device, such as user computer equipment 804. The user equipment device storing the content uploads the content to the cloud using a data transmission service on communications network 814. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 7.

As referred herein, the term “in response to” refers to initiated as a result of. For example, a first action being performed in response to a second action may include interstitial steps between the first action and the second action. As referred herein, the term “directly in response to” refers to caused by. For example, a first action being performed directly in response to a second action may not include interstitial steps between the first action and the second action.

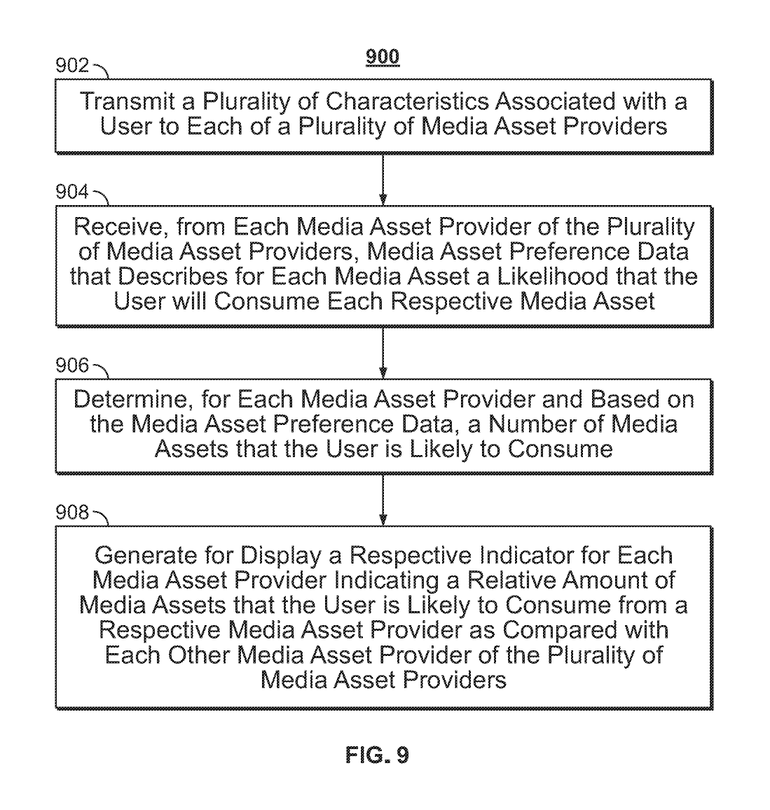

FIG. 9 is a flowchart of illustrative actions for recommending a provider for media asset consumption, in accordance with some embodiments of the disclosure. For example, a media guidance application implementing process 900 may be executed by control circuitry 704 (FIG. 7). It should be noted that process 900 or any action thereof could be performed on, or provided by, any of the devices shown in FIGS. 7-8.

Process 900 begins at 902, where the media guidance application transmits (e.g., via control circuitry 704 (FIG. 7)) a plurality of characteristics associated with a user to each of a plurality of media asset providers. For example, the media guidance application may retrieve (e.g., via control circuitry 704 (FIG. 7)) stored user preferences (e.g., stored in storage 708 (FIG. 7) or at media guidance data source 818 accessible via communications network 814 (FIG. 8)) for particular actors, directors, genres, or any other person or attribute associated with media assets as the plurality of characteristics. The stored user preferences may be explicitly set by the user (e.g., in a favorites screen) or may be determined from a viewing history associated with the user. As a specific example, if a user has consumed multiple movies starring Tom Cruise, the media guidance application may determine (e.g., via control circuitry 704 (FIG. 7)) that Tom Cruise is a favorite actor of the user. After determining the plurality of characteristics, the media guidance application may determine (e.g., via control circuitry 704 (FIG. 7)) which media asset providers (e.g., one or more content sources 816 (FIG. 8)) to transmit the plurality of characteristics to and customize the transmission based on characteristics that each media asset provider supports.

Process 900 continues to 904, where the media guidance application receives (e.g., via control circuitry 704 (FIG. 7)), from each media asset provider of the plurality of media asset providers, media asset preference data that describes for each media asset a likelihood that the user will consume each respective media asset. For example, the media guidance application may receive (e.g., via control circuitry 704 (FIG. 7)) a list, table, or other suitable data structure containing indications from each media asset provider of whether each of the plurality of characteristics matched particular media assets available from the provider. As a specific example, the media guidance application may receive (e.g., via control circuitry 704 (FIG. 7)) a table containing Boolean values that are set to “true” or “false” for the characteristics “actor” and “genre” for movies available from two different media asset providers. Based on the values in the table, the media guidance application may assign (e.g., via control circuitry 704 (FIG. 7)) a probability to each media asset for the likelihood that the user would consume the media asset.

Process 900 continues to 906, where the media guidance application determines (e.g., via control circuitry 704 (FIG. 7)), for each media asset provider and based on the media asset preference data, a number of media assets that the user is likely to consume. For example, the media guidance application may sum (e.g., via control circuitry 704 (FIG. 7)) the probability that a user will consume each media asset from a particular media asset provider (e.g., content source 816 (FIG. 8)) to calculate the number of media assets likely to be consumed by the user from the media asset provider. The media guidance application may normalize (e.g., via control circuitry 704 (FIG. 7)) the calculated numbers based on the total number of media assets available from each media asset provider (e.g., content sources 816 (FIG. 8)), or may not normalize the scores.

Process 900 continues to 908, where the media guidance application generates (e.g., via control circuitry 704 (FIG. 7)) for display (e.g., on display 712 (FIG. 7)) a respective indicator for each media asset provider indicating a relative amount of media assets that the user is likely to consume from a respective media asset provider as compared with each other media asset provider of the plurality of media asset providers. For example, the media guidance application may receive a user input (e.g., via user input interface 710 (FIG. 7)) from the user to generate (e.g., via control circuitry 704 (FIG. 7)) a display (e.g., on display 712 (FIG. 7)) with indicators of media asset providers (e.g., content sources 816 (FIG. 8)). The media guidance application may arrange, format, or otherwise visually distinguish (e.g., via control circuitry 704 (FIG. 7)) the indicators based on the associated scores, as described further with respect to FIG. 4.

It is contemplated that the steps or descriptions of FIG. 9 may be used with any other embodiment of this disclosure. In addition, the steps and descriptions described in relation to FIG. 9 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 7-8 could be used to perform one or more of the steps in FIG. 9.

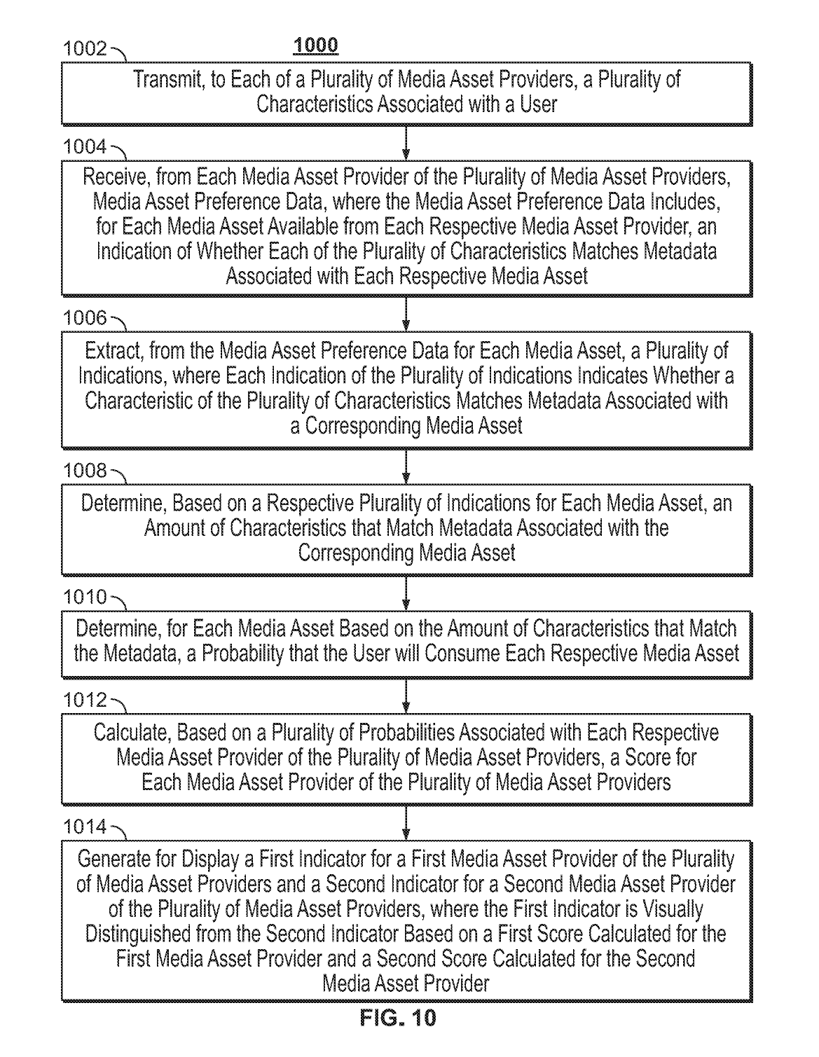

FIG. 10 is another flowchart of illustrative actions for recommending a provider for media asset consumption, in accordance with some embodiments of the disclosure. For example, a media guidance application implementing process 1000 may be executed by control circuitry 704 (FIG. 7). It should be noted that process 1000 or any action thereof could be performed on, or provided by, any of the devices shown in FIGS. 7-8.

Process 1000 begins at 1002, where the media guidance application transmits (e.g., via control circuitry 704 (FIG. 7)), to each of a plurality of media asset providers, a plurality of characteristics associated with a user. For example, the media guidance application may retrieve (e.g., via control circuitry 704 (FIG. 7)) stored user preferences (e.g., stored in storage 708 (FIG. 7) or at media guidance data source 818 accessible via communications network 814 (FIG. 8)) for particular actors, directors, genres, or any other person or attribute associated with media assets as the plurality of characteristics. The stored user preferences may be explicitly set by the user (e.g., in a favorites screen) or may be determined from a viewing history associated with the user. As a specific example, if a user has consumed multiple movies starring Tom Cruise, the media guidance application may determine (e.g., via control circuitry 704 (FIG. 7)) that Tom Cruise is a favorite actor of the user. After determining the plurality of characteristics, the media guidance application may determine (e.g., via control circuitry 704 (FIG. 7)) which media asset providers (e.g., one or more content sources 816 (FIG. 8)) to transmit the plurality of characteristics to and customize the transmission based on characteristics that each media asset provider supports.

Process 1000 continues to 1004, where the media guidance application receives (e.g., via control circuitry 704 (FIG. 7)), from each media asset provider of the plurality of media asset providers, media asset preference data, where the media asset preference data includes, for each media asset available from each respective media asset provider, an indication of whether each of the plurality of characteristics matches metadata associated with each respective media asset. For example, the user may have five favorite actors, four of whom appear in a particular movie. In this situation, the media asset preference data received by the media guidance application (e.g., via control circuitry 704 (FIG. 7)), in addition to storing an indication of a match (e.g., a Boolean value that is set to “true”) for the “actor” characteristic, may also store the number four indicating that more than one match was found. The media guidance application may utilize (e.g., via control circuitry 704 (FIG. 7)) this information to assign a higher probability that the user will consume the media asset.

Process 1000 continues to 1006, where the media guidance application extracts (e.g., via control circuitry 704 (FIG. 7)), from the media asset preference data for each media asset, a plurality of indications, where each indication of the plurality of indications indicates whether a characteristic of the plurality of characteristics matches metadata associated with a corresponding media asset. For example, the media guidance application may process (e.g., via control circuitry 704 (FIG. 7)) the media asset preference data to group indications that refer to the same media asset. The media guidance application may also standardize (e.g., via control circuitry 704 (FIG. 7)) the indications from different media asset providers (e.g., content sources 816 (FIG. 8)) during extraction from the media asset preference data. For example, if one media asset provider transmits binary indications about whether a match was determined and another media asset provider transmits indications on a scale of 1-10, the media guidance application may convert (e.g., via control circuitry 704 (FIG. 7)) the indications to a common format in order to more easily assign probabilities to each media asset that the user will consume each media asset.

Process 1000 continues to 1008, where the media guidance application determines (e.g., via control circuitry 704 (FIG. 7)), based on a respective plurality of indications for each media asset, an amount of characteristics that match metadata associated with the corresponding media asset. For example, the media guidance application may determine (e.g., via control circuitry 704 (FIG. 7)) whether a characteristic matches based on the received media asset preference data. Continuing with this example, a particular characteristic (e.g., actor) may be associated with a Boolean value, set to either true or false, for a particular media asset from a particular media asset provider (e.g., content source 816 (FIG. 8)). The media guidance application may determine (e.g., via control circuitry 704 (FIG. 7)) a match between the characteristic and the metadata based on the true or false value without further processing.

Process 1000 continues to 1010, where the media guidance application determines (e.g., via control circuitry 704 (FIG. 7)), for each media asset based on the amount of characteristics that match the metadata, a probability that the user will consume each respective media asset. As one example, the media guidance application may determine (e.g., via control circuitry 704 (FIG. 7)) that the percentage of characteristics that match out of the total number of the plurality of characteristics is the probability. In this example, if 5 out of 10 characteristics match for a media asset, the media guidance application may assign (e.g., via control circuitry 704 (FIG. 7)) 50% as the probability for the media asset. As another example, the media guidance application may weigh (e.g., via control circuitry 704 (FIG. 7)) certain factors higher or lower (e.g., based on user preferences). In this example, if a user has a strong preference for his or her favorite actors being in media assets, but less of a preference for the genre, then the media guidance application may assign (e.g., via control circuitry 704 (FIG. 7)) a media asset matching only the actor characteristic a higher probability than another media asset matching only the genre characteristic.

Process 1000 continues to 1012, where the media guidance application calculates (e.g., via control circuitry 704 (FIG. 7)), based on a plurality of probabilities associated with each respective media asset provider of the plurality of media asset providers, a score for each media asset provider of the plurality of media asset providers. For example, the media guidance application may sum (e.g., via control circuitry 704 (FIG. 7)) the probability for every media asset from a particular media asset provider (e.g., content source 816 (FIG. 8)) to calculate the score for the media asset provider. The media guidance application may normalize (e.g., via control circuitry 704 (FIG. 7)) the scores based on the total number of media assets available from each media asset provider (e.g., content sources 816 (FIG. 8)), or may not normalize the scores.

Process 1000 continues to 1014, where the media guidance application generates (e.g., via control circuitry 704 (FIG. 7)) for display (e.g., on display 712 (FIG. 7)) a first indicator for a first media asset provider of the plurality of media asset providers and a second indicator for a second media asset provider of the plurality of media asset providers, where the first indicator is visually distinguished from the second indicator based on a first score calculated for the first media asset provider and a second score calculated for the second media asset provider. For example, the media guidance application may receive a user input (e.g., via user input interface 710 (FIG. 7)) from the user to generate (e.g., via control circuitry 704 (FIG. 7)) a display (e.g., on display 712 (FIG. 7)) with indicators of media asset providers (e.g., content sources 816 (FIG. 8)). The media guidance application may arrange, format, or otherwise visually distinguish (e.g., via control circuitry 704 (FIG. 7)) the indicators based on the associated scores, as described further with respect to FIG. 4.

It is contemplated that the steps or descriptions of FIG. 10 may be used with any other embodiment of this disclosure. In addition, the steps and descriptions described in relation to FIG. 10 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 7-8 could be used to perform one or more of the steps in FIG. 10.

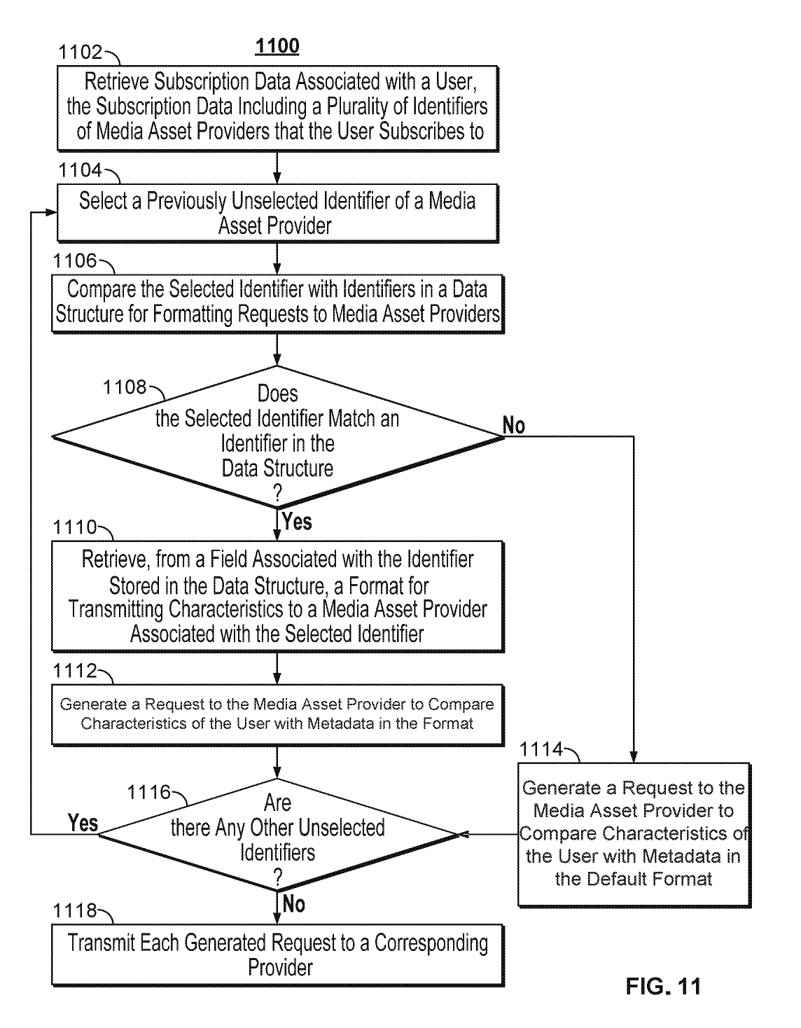

FIG. 11 is a flowchart of illustrative actions for determining which media asset providers to transmit a request to, in accordance with some embodiments of the disclosure. For example, a media guidance application implementing process 1100 may be executed by control circuitry 704 (FIG. 7) to determine which media asset providers to transmit a request to. Specifically, the media guidance application may initialize the necessary variables and execute (e.g., via control circuitry 704 (FIG. 7)) a program script calling a particular method to execute process 1100. It should be noted that process 1100 or any step thereof could be performed on, or provided by, any of the devices shown in FIGS. 7-8.

Process 1100 begins at 1102, where the media guidance application retrieves (e.g., via control circuitry 704 (FIG. 7)) subscription data associated with a user, the subscription data including a plurality of identifiers of media asset providers that the user subscribes to. For example, the media guidance application may retrieve (e.g., via control circuitry 704 (FIG. 7)) a data structure (e.g., stored in storage 708 (FIG. 7) or at media guidance data source 818 accessible via communications network 814 (FIG. 8)) including media asset providers (e.g., content sources 816 (FIG. 8)) that the user subscribes to. As a specific example, the data structure may be a list containing identifiers of media asset providers that the user has stored passwords for. As another example, the data structure may be a list containing identifiers of media asset providers that the user has explicitly indicated that he or she subscribes to (e.g., via input from user input interface 710 (FIG. 7)).

Process 1100 continues to 1104, where the media guidance application selects (e.g., via control circuitry 704 (FIG. 7)) a previously unselected identifier of a media asset provider. For example, the media guidance application may execute (e.g., via control circuitry 704 (FIG. 7)) an instruction to iteratively retrieve (e.g., by utilizing a for-loop) each identifier of a media asset provider (e.g., content sources 816 (FIG. 8)) that the user subscribes to from the subscriptions data structure to determine which media asset providers to transmit requests to and how to format the requests.

Process 1100 continues to 1106, where the media guidance application compares (e.g., via control circuitry 704 (FIG. 7)) the selected identifier with identifiers in a data structure for formatting requests to media asset providers. For example, the media guidance application may compare (e.g., via control circuitry 704 (FIG. 7)) characters of the selected identifier (e.g., “HBO”) with characters of each identifier stored in a data structure (e.g., stored in storage 708 (FIG. 7) or at media guidance data source 818 accessible via communications network 814 (FIG. 8)).

Process 1100 continues to 1108, where the media guidance application determines (e.g., via control circuitry 704 (FIG. 7)) if the selected identifier matches an identifier in the data structure. For example, the media guidance application may determine (e.g., via control circuitry 704 (FIG. 7)) a match if the characters of the selected identifier match a stored identifier, or if a threshold amount of the characters match (e.g., 90%).

If, at 1108, the media guidance application determines that the selected identifier matches an identifier in the data structure, process 1100 continues to 1110, where the media guidance application retrieves (e.g., via control circuitry 704 (FIG. 7)), from a field associated with the identifier stored in the data structure, a format for transmitting characteristics to a media asset provider associated with the selected identifier. For example, the media guidance application may retrieve (e.g., via control circuitry 704 (FIG. 7)) a template for the first media asset provider (e.g., content source 816 (FIG. 8)) including indications of how to format the plurality of characteristics and/or other information such that the first media asset provider may properly process the information from a field associated with the matched identifier.

From 1110, process 1100 continues to 1112, where the media guidance application generates (e.g., via control circuitry 704 (FIG. 7)) a request to the media asset provider to compare characteristics of the user with metadata in the format. For example, upon determining the supported format (e.g., based on retrieving the template at 1110), the media guidance application may generate (e.g., via control circuitry 704 (FIG. 7)) a request to transmit, in the supported format, to the first media asset provider (e.g., content source 816 (FIG. 8)). Continuing with this example, the media guidance application may populate (e.g., via control circuitry 704 (FIG. 7)) the retrieved template with the appropriate values in the appropriate fields.

If, at 1108, the media guidance application determines that the selected identifier does not match an identifier in the data structure, process 1100 continues to 1114, where the media guidance application generates (e.g., via control circuitry 704 (FIG. 7)) a request to the media asset provider to compare characteristics of the user with metadata in a default format. For example, the media guidance application may, upon not determining a match, retrieve (e.g., via control circuitry 704 (FIG. 7)) a default template from the data structure. Continuing with this example, the media guidance application may populate (e.g., via control circuitry 704 (FIG. 7)) the retrieved template with the appropriate values in the appropriate fields.

After actions 1112 and 1114, process 1100 continues to 1116, where the media guidance application determines (e.g., via control circuitry 704 (FIG. 7)) if there are any other unselected identifiers. As discussed above with respect to action 1104, the media guidance application may execute (e.g., via control circuitry 704 (FIG. 7)) an instruction to iteratively retrieve (e.g., by utilizing a for-loop) each identifier of a media asset provider stored in the subscriptions data structure. If the loop executed by the media guidance application terminates, the media guidance application may determine that every identifier has been retrieved. If, at 1116, the media guidance application determines that there are other unselected identifiers of media asset providers, then process 1100 returns to 1104, where the media guidance application selects (e.g., via control circuitry 704 (FIG. 7)) a previously unselected identifier of a media asset provider, as described above.

If, at 1116, the media guidance application determines that there are not any other unselected identifiers, process 1100 continues to 1118, where the media guidance application transmits (e.g., via control circuitry 704 (FIG. 7)) each generated request to a corresponding provider. For example, the media guidance application may interface (e.g., via control circuitry 704 (FIG. 7)) with an application programming interface (API) for each media asset provider (e.g., content source 816 (FIG. 8)) to transmit each request to the appropriate media asset provider via a communications network (e.g., communications network 814 (FIG. 8)).

It is contemplated that the steps or descriptions of FIG. 11 may be used with any other embodiment of this disclosure. In addition, the steps and descriptions described in relation to FIG. 11 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 7-8 could be used to perform one or more of the steps in FIG. 11.

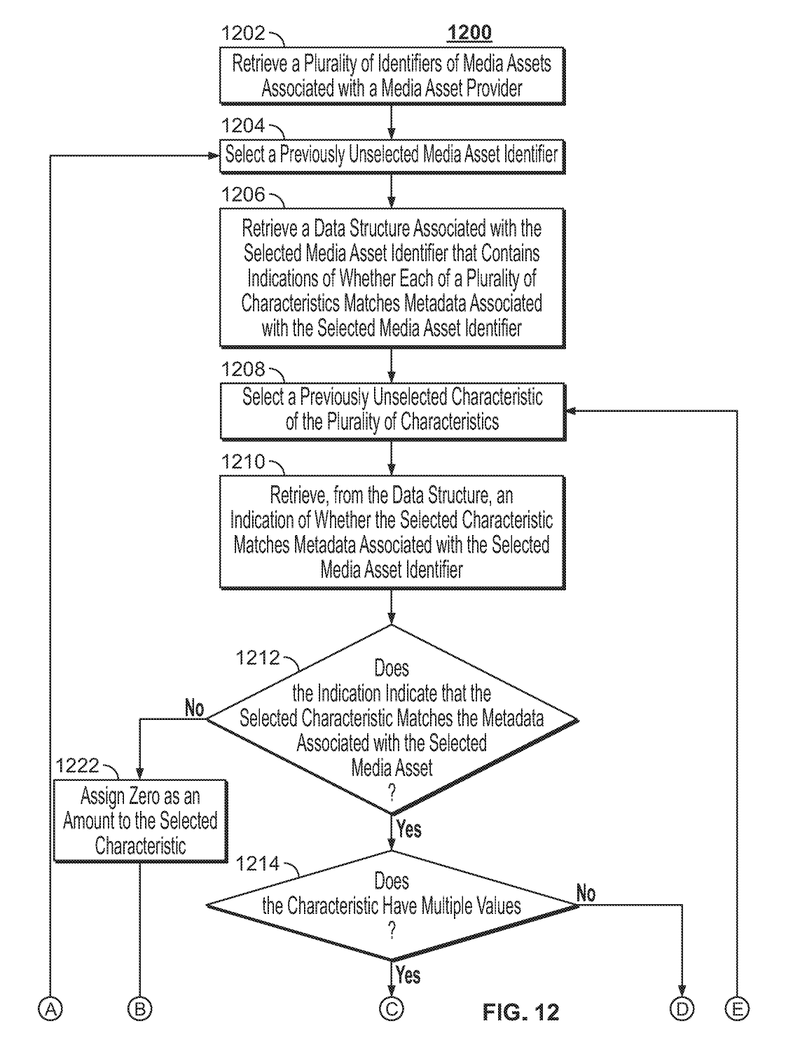

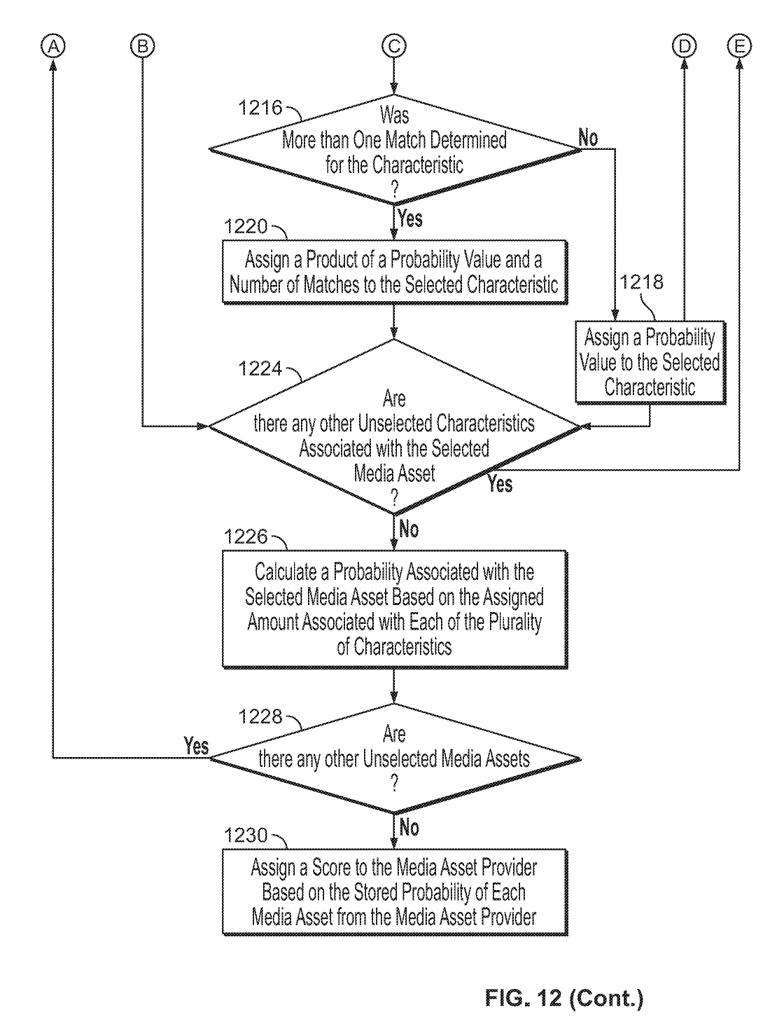

FIG. 12 is a flowchart of illustrative actions for assigning a probability that a user will consume each media asset received from a media asset provider, in accordance with some embodiments of the disclosure. For example, a media guidance application implementing process 1200 may be executed by control circuitry 704 (FIG. 7) to assign a probability that a user will consume each media asset received from a media asset provider. Specifically, the media guidance application may initialize the necessary variables and execute (e.g., via control circuitry 704 (FIG. 7)) a program script calling a particular method to execute process 1200. It should be noted that process 1200 or any step thereof could be performed on, or provided by, any of the devices shown in FIGS. 7-8.

Process 1200 begins at 1202, where the media guidance application retrieves (e.g., via control circuitry 704 (FIG. 7)) a plurality of identifiers of media assets associated with a media asset provider. For example, the media guidance application may retrieve (e.g., via control circuitry 704 (FIG. 7)) the plurality of identifiers from the media asset provider (e.g., by transmitting a request to the media asset provider). Alternatively or additionally, the media guidance application may retrieve the identifiers (e.g., via control circuitry 704 (FIG. 7)) from media asset preference data received from the media asset provider (e.g., content source 816 (FIG. 8)), as described above with respect to FIG. 1, or from extracted data from the media asset preference data for a media asset, as described above with respect to FIG. 2. The identifiers may be any combination of characters that differentiate each media asset from other media assets available from the media asset provider (e.g., content source 816 (FIG. 8)).

Process 1200 continues to 1204, where the media guidance application selects (e.g., via control circuitry 704 (FIG. 7)) a previously unselected media asset identifier. For example, the media guidance application may execute (e.g., via control circuitry 704 (FIG. 7)) an instruction to iteratively select (e.g., by utilizing a for-loop) each identifier of a media asset that is available from a particular media asset provider (e.g., content source 816 (FIG. 8)) from the retrieved plurality of identifiers.

Process 1200 continues to 1206, where the media guidance application retrieves (e.g., via control circuitry 704 (FIG. 7)) a data structure associated with the selected media asset identifier that contains indications of whether each of a plurality of characteristics matches metadata associated with the selected media asset. For example, the media guidance application may retrieve (e.g., via control circuitry 704 (FIG. 7)) a data structure that was extracted from the media asset preference data (e.g., as described above with respect to FIG. 2) for the selected media asset. Continuing with this example, the media guidance application may chose (e.g., via control circuitry 704 (FIG. 7)) the data structure relating to the selected media asset by comparing an identifier of the selected media asset with a media asset identifier referenced by the data structure. The data structure may contain a plurality of characteristics (e.g., actor, genre, director, etc.) that were compared between the user and the selected media asset.

Process 1200 continues to 1208, where the media guidance application selects (e.g., via control circuitry 704 (FIG. 7)) a previously unselected characteristic of the plurality of characteristics. For example, the media guidance application may execute (e.g., via control circuitry 704 (FIG. 7)) an instruction to iteratively select (e.g., by utilizing a for-loop) each characteristic from the data structure associated with the selected media asset.

Process 1200 continues to 1210, where the media guidance application retrieves (e.g., via control circuitry 704 (FIG. 7)), from the data structure, an indication of whether the selected characteristic matches metadata associated with the selected media asset. For example, the media guidance application may execute (e.g., via control circuitry 704 (FIG. 7)) a script in a database query language to retrieve a value from a field of the data structure corresponding to the selected characteristic. As a specific example, the media guidance application may retrieve (e.g., via control circuitry 704 (FIG. 7)) a Boolean value set to “true” for the “actor” characteristic of a particular media asset, indicating that one or more of the user's favorite actors is in a particular media asset.

Process 1200 continues to 1212, where the media guidance application determines (e.g., via control circuitry 704 (FIG. 7)) whether the indication indicates that the selected characteristic matches the metadata associated with the selected media asset. For example a particular characteristic (e.g., actor) may be associated with a Boolean value, set to either true or false, for a particular media asset from a particular media asset provider. Continuing with this example the media guidance application may determine a match between the characteristic and the metadata based on the true or false value without further processing.

If, at 1212, the media guidance application determines that the selected characteristic does match the metadata associated with the selected media asset, process 1200 continues to 1214, where the media guidance application determines (e.g., via control circuitry 704 (FIG. 7)) whether the characteristic has multiple values. For example, the media guidance application may determine (e.g., via control circuitry 704 (FIG. 7)) that a particular characteristic has multiple associated values for the user. As a specific example, the media guidance application may determine (e.g., via control circuitry 704 (FIG. 7)) that the user has five favorite actors that are part of an “actor” characteristic, and may transmit all five actors to the plurality of media asset providers to provide accurate analysis of whether a user is likely to consume media assets. Based on knowledge (e.g., a stored indication that multiple values were transmitted for a category) the media guidance application may determine (e.g., via control circuitry 704 (FIG. 7)) how many of the values matched metadata of a media asset.

If, at 1214, the media guidance application determines that the selected characteristic does not have multiple values, process 1200 continues to 1218, where the media guidance application assigns (e.g., via control circuitry 704 (FIG. 7)) a probability value to the selected characteristic. For example, the media guidance application may retrieve (e.g., via control circuitry 704 (FIG. 7)) a value to assign to the characteristic from a data structure (e.g., 0.05) and assign the value to the selected characteristic. Process 1200 then continues to 1224.

If, at 1214, the media guidance application determines that the selected characteristic does have multiple values, process 1200 continues to 1216, where the media guidance application determines (e.g., via control circuitry 704 (FIG. 7)) if more than one match was determined for the characteristic. For example, the media guidance application may retrieve (e.g., via control circuitry 704 (FIG. 7)) a stored value (e.g., an integer) indicating the number of the transmitted values (e.g., multiple actors that the user enjoys) that matched metadata for the selected media asset (e.g., as described above with respect to FIGS. 1-2). As a specific example, if the user has an indicated a preference for both “Tom Cruise” and “Emily Blunt” for the “actor” characteristic, then the media guidance application may extract (e.g., via control circuitry 704 (FIG. 7)) a value of “2” from a field associated with the number of matches for the actor category for the movie “Edge of Tomorrow” because both actors are in the movie.

If, at 1216, the media guidance application determines only one match for the selected characteristic, then process 1200 continues to 1218, where the media guidance application assigns (e.g., via control circuitry 704 (FIG. 7)) a probability value to the selected characteristic, as described above. For example, the media guidance application may retrieve (e.g., via control circuitry 704 (FIG. 7)) a value to assign to the characteristic from a data structure (e.g., 0.05) and assign the value to the selected characteristic. Process 1200 then continues to 1224.

If, at 1216, the media guidance application determines more than one match for the selected characteristic, then process 1200 continues to 1220, where the media guidance application assigns (e.g., via control circuitry 704 (FIG. 7)) a product of a probability value and a number of matches to the selected characteristic. For example, if the media guidance application determines (e.g., via control circuitry 704 (FIG. 7)) that a particular characteristic had multiple associated values (e.g., the user has multiple favorite “actors”) and two of those actors are in the selected media asset, then the media guidance application may multiple the amount that would be assigned to a single match by two to reflect the multiple matches. As a specific example, if the media guidance application would assign (e.g., via control circuitry 704 (FIG. 7)) a single match for the actor characteristic a value of 0.05, then two matches may be assigned 0.1. Process 1200 then continues to 1224.

If, at 1212, the media guidance application determines that the selected characteristic does not match the metadata associated with the selected media asset, process 1200 continues to 1222, where the media guidance application assigns (e.g., via control circuitry 704 (FIG. 7)) zero as an amount to the selected characteristic. For example, if a particular characteristic (e.g., actor) does not match the metadata of a particular media asset (e.g., the actors in the media asset do not match the user's favorite actors), then the media guidance application may assign (e.g., via control circuitry 704 (FIG. 7)) a value of zero to the characteristic since it does not match the user's preferences. Process 1200 then continues to 1224.

Process 1200 continues to 1224, where the media guidance application determines (e.g., via control circuitry 704 (FIG. 7)) whether there are any other unselected characteristics associated with the selected media asset. As discussed above with respect to action 1208, the media guidance application may execute (e.g., via control circuitry 704 (FIG. 7)) an instruction to iteratively retrieve (e.g., by utilizing a for-loop) each characteristic from a data structure for the selected media asset. If the loop executed by the media guidance application terminates, the media guidance application may determine that every characteristic has been retrieved. If, at 1224, the media guidance application determines that there is another unselected characteristic, then process 1200 returns to 1208, where the media guidance application selects (e.g., via control circuitry 704 (FIG. 7)) a previously unselected characteristic of the plurality of characteristics, as described above.

If, at 1224, the media guidance application determines that there is not another unselected characteristic, then process 1200 continues to 1226, where the media guidance application calculates (e.g., via control circuitry 704 (FIG. 7)) a probability associated with the selected media asset based on the assigned amount associated with each of the plurality of characteristics. For example, the media guidance application may sum (e.g., via control circuitry 704 (FIG. 7)) the amounts assigned to each of the characteristics for a particular media asset as the probability that the user will consume the media asset. As a specific example, the media guidance application may determine (e.g., via control circuitry 704 (FIG. 7)) that 0.1 was assigned to one characteristic, 0.2 was assigned to another characteristic, and nothing was assigned to any other characteristics. Accordingly, the media guidance application may store (e.g., via control circuitry 704 (FIG. 7)) a value of 0.3 (e.g., representing a 30% chance that the user will consume the media asset) for the media asset in a data structure (e.g., stored in storage 708 (FIG. 7) or at media guidance data source 818 accessible via communications network 814 (FIG. 8)).

Process 1200 continues to 1228, where the media guidance application determines (e.g., via control circuitry 704 (FIG. 7)) whether there are any other unselected media assets. As discussed above with respect to action 1204, the media guidance application may select (e.g., by utilizing a for-loop) each identifier of a media asset that is available from a particular media asset provider (e.g., content source 816 (FIG. 8)) from the retrieved plurality of identifiers. If the loop executed by the media guidance application terminates, the media guidance application may determine that every media asset from a particular media asset provider has been retrieved. If, at 1228, the media guidance application determines that there is another unselected media asset, then process 1200 returns to 1204, where the media guidance application selects (e.g., via control circuitry 704 (FIG. 7)) a previously unselected media asset, as described above.

If, at 1228, the media guidance application determines that there is not another unselected media asset, then process 1200 continues to 1230, where the media guidance application assigns (e.g., via control circuitry 704 (FIG. 7)) a score to the media asset provider based on the stored probability of each media asset from the media asset provider. For example, the media guidance application may sum (e.g., via control circuitry 704 (FIG. 7)) the probability for every media asset from a particular media asset provider to calculate the score for the media asset provider.

It is contemplated that the steps or descriptions of FIG. 12 may be used with any other embodiment of this disclosure. In addition, the steps and descriptions described in relation to FIG. 12 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 7-8 could be used to perform one or more of the steps in FIG. 12.

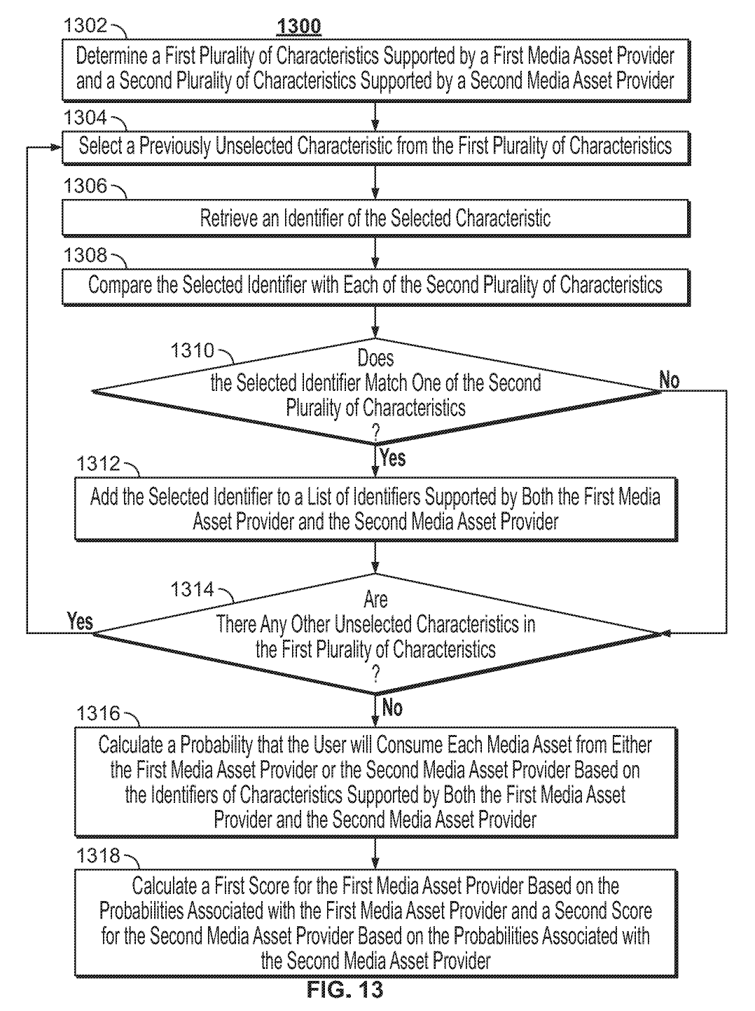

FIG. 13 is a flowchart of illustrative actions for determining an overlap between characteristics supported by two media asset providers, in accordance with some embodiments of the disclosure. For example, a media guidance application implementing process 1300 may be executed by control circuitry 704 (FIG. 7) to determine an overlap between characteristics supported by two media asset providers. Specifically, the media guidance application may initialize the necessary variables and execute (e.g., via control circuitry 704 (FIG. 7)) a program script calling a particular method to execute process 1300. It should be noted that process 1300 or any step thereof could be performed on, or provided by, any of the devices shown in FIGS. 7-8.

Process 1300 begins at 1302, where the media guidance application determines (e.g., via control circuitry 704 (FIG. 7)) a first plurality of characteristics supported by a first media asset provider and a second plurality of characteristics supported by a second media asset provider. For example, the media guidance application may transmit (e.g., via control circuitry 704 (FIG. 7)) requests to two or more media asset provider for a list or other data structure that contains characteristics that each media asset provider supports. The media guidance application may receive (e.g., via control circuitry 704 (FIG. 7)), from each media asset provider, a set of identifiers of characteristics that each media asset provider supports. For example, the media guidance application may receive (e.g., via control circuitry 704 (FIG. 7)) a list or other data structure containing identifiers (e.g., “actor”) of characteristics that the media asset provider supports (e.g., that the media asset provider will be able to compare with metadata).

Process 1300 continues to 1304, where the media guidance application selects (e.g., via control circuitry 704 (FIG. 7)) a previously unselected characteristic from the first plurality of characteristics. For example, the media guidance application may execute (e.g., via control circuitry 704 (FIG. 7)) an instruction to iteratively select (e.g., by utilizing a for-loop) each characteristic from the first plurality of characteristics (e.g., that the first media asset provider will be able to compare with metadata).

Process 1300 continues to 1306, where the media guidance application retrieves (e.g., via control circuitry 704 (FIG. 7)) an identifier of the selected characteristic. For example, the media guidance application may retrieve (e.g., via control circuitry 704 (FIG. 7)) an identifier of the selected characteristic from a list or other data structure (e.g., stored in storage 708 (FIG. 7) or at media guidance data source 818 accessible via communications network 814 (FIG. 8)). The identifier may be any string of characters that differentiates the identifier from other identifiers, such as the name of the identifier (e.g., “actor”).

Process 1300 continues to 1308, where the media guidance application compares (e.g., via control circuitry 704 (FIG. 7)) the selected identifier with each of the second plurality of characteristics. For example, the media guidance application may compare (e.g., via control circuitry 704 (FIG. 7)) characters of each identifier from the first plurality of characteristics (e.g., “actor”) from a first media asset provider with characters of each identifier of a second plurality of characteristics from a different media asset provider.

Process 1300 continues to 1310, where the media guidance application determines (e.g., via control circuitry 704 (FIG. 7)) if the selected identifier matches one of the second plurality of characteristics. For example, the media guidance application may determine (e.g., via control circuitry 704 (FIG. 7)) a match if the characters of the selected identifier match every character of an identifier of one of the second plurality of characteristics, or if a threshold amount of the characters match (e.g., 90%).

If, at 1310, the media guidance application determines that the selected identifier does match one of the second plurality of characteristics, process 1300 continues to 1312, where the media guidance application adds (e.g., via control circuitry 704 (FIG. 7)) the selected identifier to a list of identifiers supported by both the first media asset provider and the second media asset provider. For example, the media guidance application may store (e.g., stored in storage 708 (FIG. 7) or at media guidance data source 818 accessible via communications network 814 (FIG. 8)), in a list or other data structure, the selected identifier with an indication that it was supported by both media asset providers. The media guidance application may access (e.g., via control circuitry 704 (FIG. 7)) the list or other data structure to determine which characteristics to use when calculating probabilities so that a media asset provider that compares more characteristics than another does not skew the probability calculation. Process 1300 then proceeds to 1314.

If, at 1310, the media guidance application determines that the selected identifier does not match one of the second plurality of characteristics, process 1300 continues to 1314, where the media guidance application determines (e.g., via control circuitry 704 (FIG. 7)) whether there are any other unselected characteristics in the first plurality of characteristics. As discussed above with respect to action 1304, the media guidance application may execute (e.g., via control circuitry 704 (FIG. 7)) an instruction to iteratively select (e.g., by utilizing a for-loop) each characteristic from the first plurality of characteristics (e.g., that the first media asset provider will be able to compare with metadata). If the loop executed by the media guidance application terminates, the media guidance application may determine that every characteristic has been retrieved. If, at 1314, the media guidance application determines that there are other unselected identifiers of media asset providers, then process 1300 returns to 1304, where the media guidance application selects (e.g., via control circuitry 704 (FIG. 7)) a previously unselected characteristic from the first plurality of characteristics, as described above.

If, at 1314, the media guidance application determines that there are not any other unselected characteristics, process 1300 continues to 1316, where the media guidance application calculates (e.g., via control circuitry 704 (FIG. 7)) a probability that the user will consume each media asset from either the first media asset provider or the second media asset provider based on the identifiers of characteristics supported by both the first media asset provider and the second media asset provider. For example, if one provider (e.g., content source 816 (FIG. 8)) supports characteristics for actor, genre, and director, and the other provider supports characteristics for actor and director only, then the media guidance application may determine (e.g., via control circuitry 704 (FIG. 7)) that actor and director were used by both providers, but genre was not. Thus, whether the media guidance application determines (e.g., via control circuitry 704 (FIG. 7)) a match for the actor and director characteristics with each media asset may be used when calculating the probability, but genre may not be factored into the probability calculation. In general, the media guidance application may use only the characteristics in the set of characteristics (e.g., the characteristics that overlap between the two providers) when calculating the probability to ensure that the same number of characteristics is used from different providers, some of which may have provided additional matches that may skew the probability calculation.

Process 1300 continues to 1318, where the media guidance application calculates (e.g., via control circuitry 704 (FIG. 7)) a first score for the first media asset provider based on the probabilities associated with the first media asset provider and a second score for the second media asset provider based on the probabilities associated with the second media asset provider. For example, the media guidance application may sum (e.g., via control circuitry 704 (FIG. 7)) the probability for every media asset from a particular media asset provider (e.g., content source 816 (FIG. 8)) to calculate the score for the media asset provider.

It is contemplated that the steps or descriptions of FIG. 13 may be used with any other embodiment of this disclosure. In addition, the steps and descriptions described in relation to FIG. 13 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 7-8 could be used to perform one or more of the steps in FIG. 13.

While some portions of this disclosure may make reference to “convention,” any such reference is merely for the purpose of providing context to the invention(s) of the instant disclosure, and does not form any admission as to what constitutes the state of the art.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. (canceled)

2. A method for recommending a provider for media asset consumption, the method comprising:
transmitting, to each of a plurality of media asset providers, a plurality of characteristics associated with a user;
receiving, from each media asset provider of the plurality of media asset providers, media asset preference data, wherein the media asset preference data includes, for each media asset available from each respective media asset provider, an indication of whether each of the plurality of characteristics matches metadata associated with each respective media asset;
extracting, from the media asset preference data for each media asset, a plurality of indications, wherein each indication of the plurality of indications indicates whether a characteristic of the plurality of characteristics matches metadata associated with a corresponding media asset;
determining, based on a respective plurality of indications for each media asset, an amount of characteristics that match metadata associated with the corresponding media asset;
determining, for each media asset based on the amount of characteristics that match the metadata, a probability that the user will consume each respective media asset;
calculating, based on a plurality of probabilities associated with each respective media asset provider of the plurality of media asset providers, a score for each media asset provider of the plurality of media asset providers; and
generating for display a first indicator for a first media asset provider of the plurality of media asset providers and a second indicator for a second media asset provider of the plurality of media asset providers, wherein the first indicator is visually distinguished from the second indicator based on a first score calculated for the first media asset provider and a second score calculated for the second media asset provider.

3. The method of claim 2, wherein transmitting, to each of the plurality of media asset providers, the plurality of characteristics associated with the user comprises:
determining, for a first media asset provider of the plurality of media asset providers, a supported format for receiving characteristics;
generating a request for the first media asset provider of the plurality of media asset providers, wherein the request includes the plurality of characteristics formatted in the supported format for the first media asset provider; and
transmitting, to the first media asset provider, the request formatted in the supported format.

4. The method of claim of claim 2, wherein transmitting the plurality of characteristics associated with the user to each of the plurality of media asset providers comprises:
determining, based on subscription data associated with the user, that the user subscribes to each of the plurality of media asset providers; and
in response to determining that the user subscribes to each of the plurality of media asset providers, transmitting the plurality of characteristics associated with the user to each of the plurality of media asset providers without transmitting the plurality of characteristics to other media asset providers.

5. The method of claim 2, wherein transmitting the plurality of characteristics associated with the user to each of the plurality of media asset providers comprises:
transmitting a request to a first media asset provider of the plurality of media asset providers for a set of identifiers of characteristics that the first media asset provider supports;
receiving, from the first media asset provider, the set of identifiers of characteristics that the first media asset provider supports;
selecting, to be included in the first plurality of characteristics, characteristics associated with the user that are associated with the set of identifiers; and
transmitting, to the first media asset provider, the plurality of characteristics.

6. The method of claim 2, wherein extracting, from the media asset preference data for each media asset, the plurality of indications comprises:
generating a data structure for a first media asset from a first media asset provider, wherein the data structure comprises a field for each characteristic;
extracting, from an indication associated with the first media asset from the first media asset provider, a value for whether the corresponding characteristic matches metadata associated with the first media asset;
storing the extracted value in a corresponding field of the data structure.

7. The method of claim 2, wherein determining, for each media asset based on the amount of characteristics that match, the probability that the user will consume each respective media asset comprises:
determining, from the media asset preference data, that a first media asset provider of the plurality of media asset providers supports a first plurality of characteristics and a second media asset provider of the plurality of media asset providers supports a second plurality of characteristics;
determining a set of characteristics that are included in both the first plurality of characteristics and the second plurality of characteristics; and
determining, for each media asset from the first media asset provider and the second media asset provider based on the amount of characteristics in the set of characteristics that match, the probability that the user will consume each respective media asset.

8. The method of claim 2, wherein determining, for each media asset based on the amount of characteristics that match, the probability that the user will consume each respective media asset comprises:
determining that a first characteristic of the plurality of characteristics has multiple values;
searching, in the media asset preference data associated with the first media asset provider, for a field that corresponds to a first characteristic of the first media asset;
extracting, from the field, a number of the multiple values that match metadata associated with the first media asset; and
calculating a sum of (1) the probability that the user will consume the first media asset and (2) the number of multiple values.

9. The method of claim 2, further comprising:
determining, based on the scores for each media asset provider of the plurality of media asset providers, that the user does not subscribe to a first media asset provider with a highest score; and
in response to determining that the user does not currently subscribe to the first media asset provider with the highest score, generating for display supplemental content associated with the media asset provider.

10. The method of claim 2, wherein determining, for each media asset based on the amount of characteristics that match, the probability that the user will consume each respective media asset comprises:
retrieving a viewing history associated with the user;
determining whether a media asset in the viewing history matches a first media asset from a first media asset provider of the plurality of media asset providers; and
in response to determining that the media asset in the viewing history matches the first media asset, assigning a probability of zero to the first media asset.

11. The method of claim 2, wherein generating for display the first indicator for the first media asset provider of the plurality of media asset providers and the second indicator for the second media asset provider of the plurality of media asset providers comprises at least one of:
in response to determining that the first score is greater than the second score, generating for display the first indicator of a first size that is larger than the second indicator;
in response to determining that the first score is greater than the second score, generating for display the first indicator with a first background color indicating that the first score is greater than the second score and the second indicator with a second background color indicating that the second score is less than the first score;
in response to determining that the first score is greater than the second score, generating for display the first indicator in a first position on a screen and the second indicator in a second position on the screen, wherein the first position is more prominent than the second position; and
generating for display the first score with the first indicator and the second score with the second indicator.

12. A system for recommending a provider for media asset consumption, the system comprising:
communications circuitry configured to transmit, to each of a plurality of media asset providers, a plurality of characteristics associated with a user; and
control circuitry configured to:
receive, from each media asset provider of the plurality of media asset providers, media asset preference data, wherein the media asset preference data includes, for each media asset available from each respective media asset provider, an indication of whether each of the plurality of characteristics matches metadata associated with each respective media asset;
extract, from the media asset preference data for each media asset, a plurality of indications, wherein each indication of the plurality of indications indicates whether a characteristic of the plurality of characteristics matches metadata associated with a corresponding media asset;
determine, based on a respective plurality of indications for each media asset, an amount of characteristics that match metadata associated with the corresponding media asset;
determine, for each media asset based on the amount of characteristics that match the metadata, a probability that the user will consume each respective media asset;
calculate, based on a plurality of probabilities associated with each respective media asset provider of the plurality of media asset providers, a score for each media asset provider of the plurality of media asset providers; and
generate for display a first indicator for a first media asset provider of the plurality of media asset providers and a second indicator for a second media asset provider of the plurality of media asset providers, wherein the first indicator is visually distinguished from the second indicator based on a first score calculated for the first media asset provider and a second score calculated for the second media asset provider.

13. The system of claim 12, wherein the control circuitry is configured, when transmitting, to each of the plurality of media asset providers, the plurality of characteristics associated with the user, to:
determine, for a first media asset provider of the plurality of media asset providers, a supported format for receiving characteristics;
generate a request for the first media asset provider of the plurality of media asset providers, wherein the request includes the plurality of characteristics formatted in the supported format for the first media asset provider; and
transmit, to the first media asset provider, the request formatted in the supported format.

14. The system of claim of claim 12, wherein the control circuitry is configured, when transmitting the plurality of characteristics associated with the user to each of the plurality of media asset providers, to:
determine, based on subscription data associated with the user, that the user subscribes to each of the plurality of media asset providers; and
in response to determining that the user subscribes to each of the plurality of media asset providers, transmit the plurality of characteristics associated with the user to each of the plurality of media asset providers without transmitting the plurality of characteristics to other media asset providers.

15. The system of claim 12, wherein the control circuitry is configured, when transmitting the plurality of characteristics associated with the user to each of the plurality of media asset providers, to:
transmit a request to a first media asset provider of the plurality of media asset providers for a set of identifiers of characteristics that the first media asset provider supports;
receive, from the first media asset provider, the set of identifiers of characteristics that the first media asset provider supports;
select, to be included in the first plurality of characteristics, characteristics associated with the user that are associated with the set of identifiers; and
transmit, to the first media asset provider, the plurality of characteristics.

16. The system of claim 12, wherein the control circuitry is configured, when extracting, from the media asset preference data for each media asset, the plurality of indications, to:
generate a data structure for a first media asset from a first media asset provider, wherein the data structure comprises a field for each characteristic;
extract, from an indication associated with the first media asset from the first media asset provider, a value for whether the corresponding characteristic matches metadata associated with the first media asset;
store the extracted value in a corresponding field of the data structure.

17. The system of claim 12, wherein the control circuitry is configured, when determining, for each media asset based on the amount of characteristics that match, the probability that the user will consume each respective media asset, to:
determine, from the media asset preference data, that a first media asset provider of the plurality of media asset providers supports a first plurality of characteristics and a second media asset provider of the plurality of media asset providers supports a second plurality of characteristics;
determine a set of characteristics that are included in both the first plurality of characteristics and the second plurality of characteristics; and
determine, for each media asset from the first media asset provider and the second media asset provider based on the amount of characteristics in the set of characteristics that match, the probability that the user will consume each respective media asset.

18. The system of claim 12, wherein the control circuitry is configured, when determining, for each media asset based on the amount of characteristics that match, the probability that the user will consume each respective media asset, to:
determine that a first characteristic of the plurality of characteristics has multiple values;
search, in the media asset preference data associated with the first media asset provider, for a field that corresponds to a first characteristic of the first media asset;
extract, from the field, a number of the multiple values that match metadata associated with the first media asset; and
calculate a sum of (1) the probability that the user will consume the first media asset and (2) the number of multiple values.

19. The system of claim 12, wherein the control circuitry is further configured to:
determine, based on the scores for each media asset provider of the plurality of media asset providers, that the user does not subscribe to a first media asset provider with a highest score; and
in response to determining that the user does not currently subscribe to the first media asset provider with the highest score, generate for display supplemental content associated with the media asset provider.

20. The system of claim 12, wherein the control circuitry is configured, when determining, for each media asset based on the amount of characteristics that match, the probability that the user will consume each respective media asset, to:
retrieve a viewing history associated with the user;
determine whether a media asset in the viewing history matches a first media asset from a first media asset provider of the plurality of media asset providers; and
in response to determining that the media asset in the viewing history matches the first media asset, assign a probability of zero to the first media asset.

21. The system of claim 12, wherein the control circuitry is configured, when generating for display the first indicator for the first media asset provider of the plurality of media asset providers and the second indicator for the second media asset provider of the plurality of media asset providers, to, at least one of:
in response to determining that the first score is greater than the second score, generate for display the first indicator of a first size that is larger than the second indicator;
in response to determining that the first score is greater than the second score, generate for display the first indicator with a first background color indicating that the first score is greater than the second score and the second indicator with a second background color indicating that the second score is less than the first score;
in response to determining that the first score is greater than the second score, generate for display the first indicator in a first position on a screen and the second indicator in a second position on the screen, wherein the first position is more prominent than the second position; and
generate for display the first score with the first indicator and the second score with the second indicator.

22.-51. (canceled)
